(19) United States
(12) Patent Application Publication
(10) Pub. No.: US 2013/0229291 A1
(43) Pub. Date: Sep. 5, 2013

(54) IMAGE FORMING METHOD

(71) Applicant: FUJIFILM CORPORATION, Tokyo (JP)

(72) Inventors: Atsushi KAERIYAMA, Kanagawa (JP); Kiyoshi IRITA, Kanagawa (JP)

(73) Assignee: FUJIFILM CORPORATION, Tokyo (JP)

(21) Appl. No.: 13/779,001

(22) Filed: Feb. 27, 2013

(30) Foreign Application Priority Data
Mar. 1, 2012 (JP) 2012-045814
Dec. 14, 2012 (JP) 2012-273994

(51) Int. Cl. B41J 2/14

(52) U.S. Cl. CPC B41J 2/14
USPC 341/21

(57) ABSTRACT

The image forming method includes: applying two or more kinds of ink compositions having different hues onto a recording medium to form a multi-color image, each ink composition containing a pigment, water, and 5% by mass to 15% by mass of polyvalent (meth)acrylamide represented by the following formula (1) with respect to the total amount of the ink composition; and applying a treatment solution, containing an aggregation component onto the recording medium. In the image forming method, an average diameter φ¹ (μm) of droplets of the ink compositions on the recording medium satisfies the following relational expression (1), and an application density of droplets having a minimum volume of ink composition on the recording medium is 80% or more (Q: n-valent linking group, R¹: H, methyl group, n≧2).

(2.54×10000/R)×1.5≦φ¹≦(2.54×10000/R)×1.7 Relational Expression (1)
wherein, R represents a resolution (dot per inch) of an image.

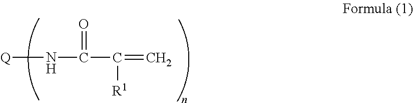

### BACKGROUND OF THE INVENTION

1. Field of the Invention

The present invention relates to an image forming method.

2. Description of the Related Art

Ink jet technology is an image forming method which is widely used in the fields of office printers, home printers, and the like and in the commercial field because a desired image can be formed on various recording media. Water-based ink attracts attention as an ink used for ink jet recording, in consideration of solvents, the global environment, and the work environment. In addition, discussion has been made regarding techniques which form an image having high wear resistance by adding polymerizable monomer components to an ink to be cured.

In the methods of forming an image using an ink jet method of the related art, there are problems relating to image quality, for example, the diameter of droplets of an ink, applied onto a recording medium, is changed and the accuracy is insufficient; or a desired hue is not developed when two or more color inks are applied to be adjacent to each other or to overlap each other.

As image forming techniques using plural kinds of inks, for example, an ink jet color recording method is disclosed in which droplets of two or more color inks are discharged onto plain paper to be adjacent to each other or to overlap each other; and a bleeding ratio, which is expressed by a ratio of the diameter of dots formed on high-quality paper to the diameter of droplets of the inks, is within a specific range (for example, refer to JP1994-024123A (JP-H06-024123A)). In this case, it is assumed that different color inks are not mixed with each other. In addition, an ink jet recording method is disclosed in which an ink composition containing a pigment, water, and a resin emulsion and a reaction solution containing a polyvalent metal salt are used (for example, refer to JP1997-207424A (JP-H09-207424A)). In this method, it is disclosed that non-uniform color mixing (color bleeding) in a boundary region between different colors can be prevented. In addition, an ink jet image forming method is disclosed in which an ink for forming dots is selected from slow-drying ink and quick-drying ink based on an ambient temperature and an ink is selected based on a pre-identified dot density to form an image (for example, refer to JP2001-225544A). Furthermore, an ink jet recording method is disclosed in which a first liquid containing a coloring material and a second liquid containing a coagulant are used to perform printing such that a predetermined relational expression based on the amounts of both liquids applied per unit area is satisfied (for example, refer to JP2006-7749A)

### SUMMARY OF THE INVENTION

In an image recording system having a configuration in which inks as coloring solutions and a solution capable of aggregating components in each of the inks (ink compositions) are used to suppress the application interference between the inks, there are many cases where color reproduction deteriorates when inks with high density are applied. In addition, streak unevenness (streak defects) may occur.

When only the above-described techniques of the related art are used in order to solve such a phenomenon, it is difficult for color reproduction to increase and for a high-quality image to be obtained. Moreover, the above-described techniques are insufficient for preventing streak unevenness.

The present invention has been made in consideration of the above-described circumstances, and an object thereof is to provide an image forming method in which an image having high color reproduction and a small amount of streak defects can be obtained when inks with high density are applied to form an image.

It was found that, when an image is formed by applying inks with high density and aggregating components (for example, a pigment and polymer particles) included in each of the inks to form aggregates, there is the optimum dot size for realizing satisfactory color reproduction and preventing streak unevenness in each aggregation system corresponding to the aggregability of ink compositions and a treatment solution composition. The present invention has been achieved based on these findings.

Specific means for achieving the above-described object is as follows.

That is, according to a first aspect of the invention, <1> there is provided an image forming method including: applying two or more kinds of ink compositions having different hues onto a recording medium to form a multi-color image, each ink composition containing at least a pigment, water, and 5% by mass to 15% by mass of polyvalent (meth)acrylamide represented by the following formula (1) with respect to the total amount of the ink composition as a polymerizable compound; and applying a treatment solution, which contains an aggregation component capable of aggregating components in each of the ink compositions, onto the recording medium. In this method, an average diameter φ¹ (μm) of droplets of the ink compositions on the recording medium satisfies the following relational expression (1), in the relational expression (1), R represents a resolution (dpi: dot per inch; hereinafter, the same shall be applied) of an image; and an application density of droplets having a minimum volume of ink composition on the recording medium is higher than or equal to 80%.

[Expression 1]

(2.54×10000/R)×1.5≦φ¹≦(2.54×10000/R)×1.7 Relational Expression (1)

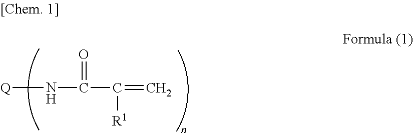

In the formula (1), Q represents an n-valent linking group; R¹ represents a hydrogen atom or a methyl group; and n represents an integer of 2 or more.)

<2> According to a second aspect of the invention, there is provided an image forming method including: applying two or more kinds of ink compositions having different hues onto a recording medium with plural droplets having different volumes of the ink compositions to form a multi-color image, each ink composition containing at least a pigment, water, and 5% by mass to 15% by mass of polyvalent (meth)acrylamide represented by the following formula (1) with respect to the total amount of the ink composition as a polymerizable compound; and applying a treatment solution, which contains an aggregation component capable of aggregating components in each of the ink compositions, onto the recording medium. In this method, among the plural droplets of the ink compositions having different volumes on the recording medium, a diameter φ² (μm) of droplets having a minimum volume of ink composition satisfies the following relational expression (2) and a diameter φ³ (μm) of droplets having a second minimum volume of ink composition satisfies the following relational expression (3) (In the relational expressions (2) and (3), R represents a resolution (dpi) of an image); and at least when an image is formed with a maximum density, an application density of droplets having the minimum volume of ink composition on the recording medium is higher than or equal to 50%, an application density of droplets having the second minimum volume of ink composition on the recording medium is higher than or equal to 10%, and a total application density of droplets of all the ink compositions on the recording medium is higher than or equal to 80%.

[Expression 2]

(2.54×10000/R)×1.5≦φ²≦(2.54×10000/R)×1.7 Relational Expression (2)

(2.54×10000/R)×2.10≦φ³≦(2.54×10000/R)×2.4 Relational Expression (3)

<3> In the image forming method according to <1> or <2> above, the resolution R is greater than or equal to 1200 dpi (dot per inch).

<4> In the image forming method according to any one of <1> to <3> above, the polyvalent (meth)acrylamide is a compound represented by the following formula (2).

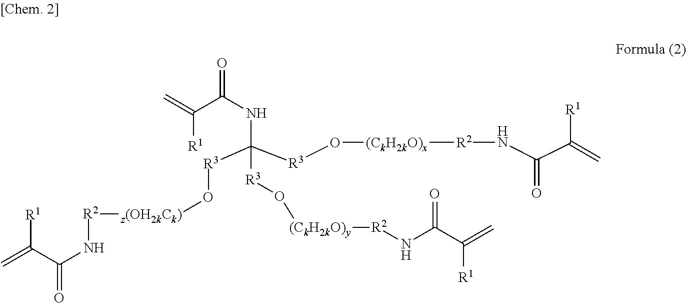

In the formula (2), R¹ represents a hydrogen atom or a methyl group; R² represents a linear or branched alkylene group having 2 to 4 carbon atoms in which an oxygen atom and a nitrogen atom, bonded to both terminals of R², are not bonded to the same carbon atom of R²; R³ represents a divalent linking group; k represents 2 or 3; and x, y, and z each independently represent an integer of 0 to 6 in which a value of x+y+z satisfies an integer of 0 to 18.

<5> In the image forming method according to any one of <1> to <4> above, the recording medium is a coated paper having a pigment layer on at least one surface of a support, which includes cellulose pulp as a major component.

<6> In the image forming method according to any one of <1> to <5> above, the coated paper is a light-weight coated paper or a fine coated paper.

<7> In the image forming method according to any one of <1> to <6> above, the pigment is a water-dispersible pigment in which at least a part of surfaces of pigment particles are coated with a polymeric dispersant.

<8> In the image forming method according to any one of <1> to <7> above, the pigment is a water-dispersible pigment in which at least a part of surfaces of pigment particles are coated with a polymeric dispersant having a carboxyl group.

<9> In the image forming method according to any one of <1> to <8> above, the recording medium is a coated paper that has a pigment layer on at least one surface of a support, which includes cellulose pulp as a major component, and that has a transfer amount of pure water of 1 ml/m² to 15 ml/m² at a contact time of 100 ms and a transfer amount of pure water 2 ml/m² to 20 ml/m² at a contact time of 400 ms when measured with a dynamic scanning absorptometer.

<10> In the image forming method according to any one of <1> to <9> above, at least one of the ink compositions and the treatment solution further contains a polymerization initiator.

According to the invention, an image forming method can be provided in which an image having high color reproduction and a small amount of streak defects can be obtained when inks with high density are applied to form an image.

### BRIEF DESCRIPTION OF THE DRAWINGS

FIG. 1 is a diagram schematically illustrating a configuration example of an ink jet recording apparatus which is used in an image forming method according to an embodiment of the invention.

### DESCRIPTION OF THE PREFERRED EMBODIMENTS

Hereinafter, an image forming method according to an embodiment of the invention will be described.

The image forming method according the embodiment includes an ink application step of applying two or more kinds of ink compositions having different hues onto a recording medium to form a multi-color image, each ink composition containing at least a pigment, water, and a polyvalent (meth)acrylamide (polymerizable compound) represented by the following formula (1); and a treatment solution application step of applying a treatment solution, which contains an aggregation component capable of aggregating components in each of the ink compositions (hereinafter, sometimes referred to as “an aggregation component capable of aggregating components in each ink”), onto the recording medium. Furthermore, the image forming method satisfies all the following conditions (i) to (iii).

(i) A content of the polyvalent (meth)acrylamide is 5% by mass to 15% by mass with respect to the total amount of the ink composition.

(ii) An average diameter φ¹ (μm) of droplets of the ink compositions on the recording medium satisfies the following relational expression (1).

(iii) An application density of droplets having a minimum volume of ink composition on the recording medium is higher than or equal to 80%.

[Expression 3]

(2.54×10000/R)×1.5≦φ¹≦(2.54×10000/R)×1.7 Relational Expression (1)

(wherein R represents a resolution (dot per inch) of an image.)

In the relational expression (1), “2.54×10000/R” defines a lattice spacing based on a resolution R and the unit “dot per inch (dpi)” of the resolution R is converted into “μm”. That is, in the relational expression (1), the average diameter φ¹ of droplets of the ink compositions on the recording medium falls within a range of 1.5 times to 1.7 times the lattice spacing.

In addition, in the relational expression, the average diameter φ¹ of droplets of the ink compositions represents “Diameter (μm) of Droplets of Ink Compositions Applied×(Application Density (%)/100)”

In the embodiment, when plural droplets of the ink compositions having different volumes are used in combination to form an image, “the application density” represents a ratio (%) of droplets of each ink composition applied per unit area.

In the embodiment, in an aggregation system using the ink compositions and the treatment solution, each ink composition containing a pigment, water, and a predetermined amount of polyvalent (meth)acrylamide, the ink compositions with high density are applied to form an image in which the application density of droplets having the minimum volume of ink composition among the plural droplets of ink compositions having different droplet sizes is higher than or equal to 80%. In this case, the average diameter (μm) of the plural droplets of ink compositions having different size, which form a multi-color image, satisfies a predetermined relationship. As a result, satisfactory color reproduction is obtained and streak unevenness is prevented. Specifically, the average value of the droplet sizes of the ink compositions, which are applied onto a recording medium and form an image, is obtained. It is preferable that the image is formed such that the average diameter of the droplets of ink compositions is 1.5 times to 1.7 times the lattice spacing, from the viewpoints of improving the color reproduction of the image and preventing streak unevenness.

That is, when aggregation occurs in the inks, the aggregability has a tendency to depend on polyvalent (meth)acrylamide (the kind of a polymerizable compound) and the content thereof; and the aggregation action of the inks imparted by the treatment solution. In a two-liquid system according to the embodiment in which the ink compositions and the treatment solution are used in combination, an image is formed so as to have a dot size within a range satisfying the relational expression (1). As a result, color reproduction is improved and streak unevenness in an image is reduced.

In the related art, it is attempted that multiple color inks are discharged onto the same recording medium to form a multi-color image. However, in practice when components in inks aggregate to form an image, there are cases that a desired hue does not appear on the image for various reasons. For example, when droplets of a first color ink are discharged and droplets of a second color ink are discharged so as to overlap each other to form a multi-color image, the first color ink is hidden by the second color ink and thus a developed color is changed; the application interference varies depending on the droplets of each ink; and the application is interfered with by the droplet sizes of the inks and the overlapping ratio of dots. In the image forming method according to the embodiment, when the droplets of the ink compositions with high density are applied onto the recording medium to form an image in which the application density of droplets having the minimum volume of ink composition is higher than or equal to 80%, the ink compositions contain a predetermined amount of polyvalent (meth)acrylamide and a pigment and the like to exhibit a predetermined aggregability; and the ink compositions are applied so as to have a droplet size within a range satisfying a predetermined relationship. As a result, the image forming method according to the embodiment has distinctive characteristics as compared to the image forming methods of the related art, in that color reproduction improves and streak unevenness is prevented.

In the relational expression (1), the resolution represented by R is selected according to a desired image. For example, when the resolution is 1000 dpi to 2000 dpi, an image having satisfactory color reproduction and a small amount of streak defects can be formed. When the resolution R is greater than or equal to 1200 dpi, effects of improving the color reproduction of an image and preventing streak defects are further improved.

Ink Application Step

In an ink application step according to the embodiment, two or more kinds of ink compositions having different hues are applied onto a recording medium to form a multi-color image. In this configuration, each ink composition contains at least a pigment, water, and a predetermined amount of polyvalent (meth)acrylamide (polymerizable compound) represented by the following formula (1). In this ink application step, a multi-color image having multiple colors is formed.

In the ink application step, when two or more kinds of ink compositions having different hues are discharged to form an image, the droplet sizes of the ink compositions to be discharged are adjusted such that the average diameter φ¹ of droplets of the ink compositions applied onto the recording medium satisfies the following relational expression (1).

In the following expression (1), the actual value of φ¹, the upper limit of φ¹ “(2.54×10000/R)×1.7” and the lower limit of φ¹ “(2.54×10000/R)×1.5” are rounded to the closest whole number.

[Expression 4]

(2.54×10000/R)×1.5≦φ¹≦(2.54×10000/R)×1.7 Relational Expression (1)

wherein R represents a resolution (dot per inch) of an image.

When the average diameter φ¹ of droplets of the ink compositions, which form an image, falls below the lower limit (which is 1.5 times the lattice spacing), color reproduction is low and streak unevenness is observed. In addition, when the average diameter φ¹ of droplets of the ink compositions exceeds the upper limit (which is 1.7 times the lattice spacing), color reproduction deteriorates. It is preferable that the average diameter φ¹ of droplets of the ink compositions be 1.55 times to 1.65 times “2.54×10000/R” from the viewpoints of improving color reproduction and preventing streak unevenness.

In the ink application step, an application density of droplets having the minimum volume of ink composition among the ink compositions which are applied onto the recording medium and form an image is set to be higher than or equal to 80%. This application density being higher than or equal to 80% represents an image being formed by applying the ink compositions with high density.

Color reproduction is improved and streak unevenness is suppressed by specifying the average diameter of droplets of the ink compositions which are applied onto the recording medium and form an image; and the application density of droplets having the minimum volume of ink composition. Furthermore, color reproduction can be further improved and streak unevenness can be further suppressed by respectively specifying the diameters and the application densities of droplets regarding the minimum volume of ink composition and a second minimum volume of ink composition.

Specifically, an ink application step of applying plural ink compositions having at least the same composition as above in which droplets of the ink compositions having different volumes are jetted onto a recording medium to form a multi-color image; and a treatment solution application step of applying a treatment solution, which contains an aggregation component capable of aggregating components in each of the ink compositions, onto the recording medium, are provided. In this configuration, the following conditions (i) and (iv) to (vii) are satisfied.

(i) A content of the polyvalent (meth)acrylamide is 5% by mass to 15% by mass with respect to the total amount of the ink composition.

(iv) Among the plural droplets of ink compositions having different volumes applied onto the recording medium, a diameter φ² (μm) of droplets having a minimum volume of ink composition satisfies the following relational expression (2).

(v) Among the plural droplets of ink compositions having different volumes applied onto the recording medium, a diameter φ³ (μm) of droplets having a second minimum volume of ink composition satisfies the following relational expression (3).

(vi) At least when an image is formed with a maximum density, an application density of droplets having the minimum volume of ink composition, which is applied onto the recording medium and forms an image, is higher than or equal to 50% and an application density of droplets having the second minimum volume of ink composition, which is applied onto the recording medium and forms an image, is higher than or equal to 10%.

(vii) A total application density of droplets of all the ink compositions applied onto the recording medium is higher than or equal to 80%.

[Expression 5]

(2.54×10000/R)×1.5≦φ²≦(2.54×10000/R)×1.7 Relational Expression (2)

(2.54×10000/R)×2.1≦φ³≦(2.54×10000/R)×2.4 Relational Expression (3)

(wherein R represents a resolution (dot per inch) of an image.)

In this configuration, the optimum dot size is selected in consideration of droplets having the minimum volume of ink composition and droplets having the second minimum volume of ink composition. That is, in an aggregation system using the ink composition and the treatment solution, each ink composition containing a pigment, water, and a predetermined amount of polyvalent (meth)acrylamide represented by the following formula (1), the ink compositions having different droplet sizes is applied with high density to form an image in which the application density of droplets having the minimum volume of ink composition is higher than or equal to 50%; the application density of droplets having the second minimum volume of ink composition is higher than or equal to 10%; and the total application density of droplets of all the ink compositions, which are applied onto the recording medium and form an image, is higher than or equal to 80%. In this case, among the plural droplets having different sizes of ink compositions (dots) which form a multi-color image, the diameter φ² of droplets having the minimum volume of ink composition and the diameter φ³ of droplets having the second minimum volume of ink composition satisfy predetermined relationships, respectively. As a result, satisfactory color reproduction is obtained and streak unevenness is effectively prevented. Specifically, it is preferable that an image is formed by the droplets of the ink composition such that the diameter φ² of droplets having the minimum volume of ink composition is 1.5 times to 1.7 times the lattice spacing and the diameter φ³ of droplets having the second minimum volume of ink composition is 2.1 times to 2.4 times the lattice spacing, from the viewpoints of improving the color reproduction of the image and preventing streak unevenness.

As described above, in the image forming method according to the embodiment, the ink compositions contain a predetermined amount of polyvalent (meth)acrylamide and a pigment and the like to exhibit a predetermined aggregability; and the ink compositions are applied so as to have a droplet size within a range in which the droplets having the minimum volume of ink composition and the droplets having the second minimum volume of ink composition satisfy predetermined relationships, respectively. As a result, the effects of improving color reproduction and preventing streak unevenness are obtained. From this point of view, the image forming method according to the embodiment has distinctive characteristics as compared to the image forming methods of the related art.

Among the plural droplets having different volumes of ink compositions which are applied to a recording medium and form an image, when the diameter φ² of droplets having the minimum volume of ink composition is greater than or equal to the lower limit (which is 1.5 times the lattice spacing), color reproduction is satisfactory and streak unevenness is reduced. In addition, when the diameter φ² of droplets having the minimum volume of ink composition is less than or equal to the upper limit (which is 1.7 times the lattice spacing), color reproduction is further improved. It is preferable that the diameter φ² be 1.55 times to 1.65 times “2.54×10000/R” from the viewpoints of improving color reproduction and preventing streak unevenness.

In the following relational expression (2), the actual value of φ², the upper limit of φ² “(2.54×10000/R)×1.7” and the lower limit of φ² “(2.54×10000/R)×1.5” are rounded to the closest whole number.

Among the plural droplets having different volumes of ink compositions which are applied to a recording medium and form an image, when the diameter φ³ of droplets having the second minimum volume of ink composition is greater than or equal to the lower limit (which is 2.1 times the lattice spacing), streak unevenness is reduced. In addition, when the diameter φ³ of droplets having the second minimum volume of ink composition is less than or equal to the upper limit (which is 2.4 times the lattice spacing), color reproduction is further improved. It is preferable that the diameter φ³ be 2.2 times to 2.3 times “2.54×10000/R” from the viewpoints of improving color reproduction and preventing streak unevenness.

In the following relational expression (3), the actual value of φ³, the upper limit of φ³ “(2.54×10000/R)×2.4” and the lower limit of φ³ “(2.54×10000/R)×2.1” are rounded to the closest whole number.

In the ink application step according to the embodiment, at least when an image is formed with a maximum density, an application density of droplets having the minimum volume of ink composition, which is applied onto the recording medium and forms an image, is higher than or equal to 50%, an application density of droplets having the second minimum volume of ink composition, which is applied onto the recording medium and forms, is higher than or equal to 10%.

When a high-density image is formed in which the application density of droplets having the minimum volume of ink composition is higher than or equal to 50%, the effect of improving the color reproduction of an image is high and streak unevenness is suppressed with higher efficiency. When the application density of droplets having the minimum volume of ink composition in an image is lower than 50%, color reproduction deteriorates and streak defects are not prevented.

In addition, when the application density of droplets having the second minimum volume of ink composition is higher than or equal to 10%, color reproduction can be improved and furthermore streak unevenness, which easily occurs in an image, can be reduced with higher efficiency. When the application density of droplets having the second minimum volume of ink composition in an image is lower than 10%, desired effects of improving color reproduction and preventing streak defects cannot be expected.

In the ink application step, the total application density of droplets of all the ink compositions, which are applied onto the recording medium and form an image, is higher than or equal to 80%. This application density being higher than or equal to 80% represents an image being formed by applying the ink compositions with high density.

In an ink jet method, energy is supplied to discharge the above-described ink compositions onto a desired recording medium. As a result, a color image is formed. As an ink jet method, which is preferable in the embodiment, a method described in paragraph to [0105] of JP2003-306623A can be used.

The ink jet method is not particularly limited, and any well-known method may be used, for example, a charge control method of using electrostatic attraction force to discharge ink; a drop-on-demand method (pressure pulse method) of using a vibration pressure of a piezoelectric element; an acoustic ink jet method of converting electric signals into acoustic beams (radiation pressure) to discharge an ink; and a thermal ink jet method (BUBBLE JET (trade name)) of heating ink to form bubbles and using a generated pressure thereof. As the ink jet method, an ink jet method described in JP1979-29936A (JP-S54-59936A) can be effectively used in which the volume of ink is rapidly changed by the action of heat energy and the ink is discharged from nozzles due to the acting force generated by the volume change.

The above-described ink jet method include a method of discharging multiple droplets of an ink having a low concentration, which is called a photo ink, in a small volume; a method of using multiple inks having substantially the same hue and different concentrations to improve image quality; and a method using a colorless transparent ink.

When the ink is applied onto the recording medium with the ink jet method, 1-pass or multi-pass recording can be used as the application method, but 1-pass or 2-pass recording is preferable from the viewpoint of high-speed recording. The 1-pass recording described herein is a recording method in which ink is discharged once to form and record all the dots (ink droplets) which should be formed in a scanning region in a direction intersecting a transport direction of a recording medium (in a direction in which recording elements are arranged). In this case, a discharge head (line head in which recording elements are arranged) having a length corresponding to a width of a substrate is provided in a width direction of the substrate intersecting a transport direction in which the recording medium is transported during recording. Ink is discharged from multiple discharge holes, which are provided in the discharge head, at the same time in a main scanning direction. This method is referred to as a so-called line method. An image is formed on the entire surface of a recording medium by scanning the recording medium in a direction (main scanning direction) intersecting an arrangement direction of recording elements. In this method, a transport system such as a carriage, which is required in a shuttle method of forming an image while scanning a short serial head in a width direction (main scanning direction) of a recording medium, is unnecessary. In addition, 2-pass recording is a recording method in which ink is discharged twice to form dots which should be formed in a scanning region.

The amount of ink droplets discharged onto an ink jet head is preferably 1 pl to 10 pl (picoliter; hereinafter, the same shall be applied) and more preferably 1.5 pl to 6 pl, from the viewpoints of obtaining a high-resolution image. In addition, a method of applying ink compositions in which droplets of the ink compositions having different volumes are jetted is effective from the viewpoints of improving the unevenness of an image and the continuity of continuous gradation. Even in this case, the image forming method according to the embodiment is desirably used.

Hereinafter, the respective components included in the ink composition according to the embodiment will be described in detail.

(Pigment)

The ink composition according to the embodiment contains at least one kind of pigment. The pigment is not particularly limited and can be appropriately selected according to the purpose. For example, either an organic pigment or an inorganic pigment may be used. As the pigment, a pigment which is substantially insoluble or insoluble in water is preferable from the viewpoint of ink colorability.

Examples of the organic pigment include azo pigments, polycyclic pigments, pigment chelates, nitro pigments, nitroso pigments, and aniline black. Among these, azo pigments or polycyclic pigments are more preferable. Examples of the inorganic pigment include titanium oxides, iron oxides, calcium carbonates, barium sulfates, aluminum hydroxide, barium yellow, cadmium red, chromium yellow, and carbon black. Among these, carbon black is more preferable.

When the organic pigment is used, it is preferable that the average particle size of the organic pigment be smaller from the viewpoints of transparency and color reproduction; whereas, be greater from the viewpoints of light resistance. From the viewpoint of improving both of these properties, the average particle size is preferably 10 nm to 200 nm, more preferably 10 nm to 150 nm, and still more preferably 10 nm to 120 nm. In addition, the particle size distribution of the organic pigment is not particularly limited, and may be a wide particle size distribution or a monodisperse particle size distribution. In addition, an organic pigment having a monodisperse particle size distribution may be used as a mixture of two or more kinds.

Dispersant

The ink composition according to the embodiment can contain at least one kind of dispersant. As a dispersant for the pigment, either a polymeric dispersant or a low-molecular-weight surfactant-type dispersant may be used. In addition, either a water-soluble dispersant or a water-insoluble dispersant may be used as the polymeric dispersant.

The low-molecular-weight surfactant-type dispersant can stably disperse a pigment in a water-soluble medium while maintaining the ink at a low viscosity. The low-molecular-weight surfactant-type dispersant is a low-molecular-weight dispersant having a molecular weight of 2,000 or less. In addition, the molecular weight of the low-molecular-weight surfactant-type dispersant is preferably 100 to 2,000 and more preferably 200 to 2,000.

The low-molecular-weight surfactant-type dispersant has a structure having a hydrophilic group and a hydrophobic group. In addition, one or more hydrophilic groups and one or more hydrophobic groups each have to only be independently included in one molecule, and the low-molecular-weight surfactant-type dispersant may include plural kinds of hydrophilic groups and hydrophobic groups. In addition, the low-molecular-weight surfactant-type dispersant may appropriately have a linking group for linking the hydrophilic group and the hydrophobic group.

Examples of the hydrophilic group include anionic groups, cationic groups, nonionic groups, and betaine groups which are combinations thereof. When the hydrophilic group is anionic, any hydrophilic groups may be used as long as they have a negative charge. As the hydrophilic group, a phosphoric acid group, a phosphonic acid group, a phosphinic acid group, a sulfuric acid group, a sulfonic acid group, a sulfinic acid group, or a carboxylic acid group is preferable, a phosphoric acid group or a carboxylic acid group is more preferable, and a carboxylic acid group is still more preferable. When the hydrophilic group is cationic, any hydrophilic groups may be used as long as they have a positive charge. An organic cationic substituent is preferable and a cationic substituent of nitrogen or phosphorus is more preferable. In addition, a pyridinium cation or ammonium cation group is still more preferable. When the hydrophilic group is nonionic, examples of the hydrophilic group include polyethylene oxide, polyglycerin, and a part of a sugar unit.

It is preferable that the hydrophilic group be an anionic substituent. As the anionic substituent, a phosphoric acid group, a phosphonic acid group, a phosphinic acid group, a sulfuric acid group, a sulfonic acid group, a sulfinic acid group, or a carboxylic acid group is preferable, a phosphoric acid group or a carboxylic acid group is more preferable, and a carboxylic acid group is still more preferable.

In addition, when the low-molecular-weight surfactant-type dispersant has an anionic hydrophilic group, it is preferable that pKa thereof be greater than or equal to 3 from the viewpoint of being brought into contact with an acidic treatment solution to accelerate an aggregation reaction. The pKa of the low-molecular-weight surfactant-type dispersant is a value which is experimentally obtained from a titration curve with a method in which 1 mmol/L of low-molecular-weight surfactant-type dispersant is dissolved in a tetrahydrofuran-water (3:2=V/V) solution to obtain a solution and this solution is titrated with an acid or an alkali aqueous solution. When the pKa of the low-molecular-weight surfactant-type dispersant is greater than or equal to 3, 50% or higher of anionic groups are theoretically undissociated when being in contact with a solution at pH 3. Therefore, the water solubility of the low-molecular-weight surfactant-type dispersant significantly deteriorates and an aggregation reaction is caused. That is, aggregation reactivity is improved. Even from this point of view, it is preferable that the low-molecular-weight surfactant-type dispersant contain a carboxylic acid group as an anionic substituent.

The hydrophobic group has, for example, a hydrocarbon-based, fluorocarbon-based, or silicone-based structure, and it is preferable that the hydrophobic group have a hydrocarbon-based structure. In addition, the hydrophobic group may have a linear or branched structure. In addition, the hydrophobic group may have one or two, or more branched structures. When two or more branched structures are used, the low-molecular-weight surfactant-type dispersant may include plural kinds of hydrophobic groups.

In addition, as the hydrophobic group, a hydrocarbon group having 2 to 24 carbon atoms is preferable, a hydrocarbon group having 4 to 24 carbon atoms is more preferable, and a hydrocarbon group having 6 to 20 carbon atoms is still more preferable.

Among the polymeric dispersants, examples of the water-soluble dispersant include hydrophilic polymer compounds. Examples of natural hydrophilic polymer compounds include plant polymers such as gum arabic, gum tragacanth, guar gum, gum karaya, locust bean gum, arabinogalactan, pectin, and quince seed starch; algae polymers such as alginic acid, carrageenan, and agar; animal polymers such as gelatin, casein, albumin, and collagen; and microbial polymers such as xanthene gum and dextran; natural polymer compound such as shellac.

In addition, examples of hydrophilic polymer compounds obtained by chemically modifying natural raw materials include cellulose polymers such as methyl cellulose, ethyl cellulose, hydroxyethyl cellulose, hydroxypropyl cellulose, and carboxymethyl cellulose; starch polymers such as sodium starch glycolate, and sodium starch phosphate; and algae polymers such as sodium alginate and propylene glycol alginate.

Furthermore, examples of synthetic hydrophilic polymer compounds include vinyl polymers such as polyvinyl alcohol, polyvinyl pyrrolidone, and polyvinyl methyl ether; non-crosslinked polyacrylamides, polyacrylic acids, and alkali metal salts thereof; acrylic resins such as water-soluble styrene acrylic resins; water-soluble styrene maleic acid resins; water-soluble vinylnaphthalene acrylic resins; water-soluble vinylnaphthalene maleic acid resins; polyvinyl pyrrolidone; polyvinyl alcohol; alkali metal salts of formalin condensates of β-naphthalene sulfonic acid; and polymer compounds having, at a side chain, a salt of a cationic functional group such as a quaternary ammonium group or an amino group.

Among these, a water-soluble dispersant, to which a carboxylic group is introduced, is preferable as the hydrophilic polymer compound, for example, a copolymer with an acrylic acid, a methacrylic acid, and a hydrophilic monomer containing other carboxylic group.

Among the polymeric dispersants, examples of the water-insoluble dispersants include polymers having both a hydrophobic group and a hydrophilic group. Examples thereof include styrene-(meth)acrylic acid copolymers, styrene-(meth)acrylic acid-(meth)acrylic acid ester copolymers, (meth)acrylic acid ester-(meth)acrylic acid copolymers, polyethylene glycol(meth)acrylate-(meth)acrylic acid copolymers, vinyl acetate-maleic acid copolymers, and styrene-maleic acid copolymers.

The weight average molecular weight of the polymeric dispersant is preferably 3,000 to 100,000, more preferably 5,000 to 50,000, still more preferably 5,000 to 40,000, and even still more preferably 10,000 to 40,000.

The weight average molecular weight of the polymeric dispersant is measured using gel permeation chromatography (GPC) in the same manner as in the case of polymer particles described below.

The polymeric dispersant contains preferably a polymer having a carboxyl group, more preferably a polymer having a carboxyl group and an acid value of 100 mgKOH/g or less, and still more preferably a polymer having a carboxyl group and an acid value of 25 mgKOH/g to 100 mgKOH/g, from the viewpoint of self-dispersibility and aggregation rate when being in contact with the treatment solution. In particular, when the ink composition according to the embodiment is used in combination with the treatment solution capable of aggregating components in the ink composition, a polymeric dispersant having a carboxylic group and an acid value of 25 mgKOH/g to 100 mgKOH/g is effective. The treatment solution will be described below.

The mixing mass ratio (p:s) of the pigment (p) to the dispersant (s) is preferably 1:0.06 to 1:3, more preferably 1:0.125 to 1:2, and still more preferably 1:0.125 to 1:1.5.

A dye may be used instead of the pigment. When a dye is used, a dye which is supported on a water-insoluble carrier can be used. The carrier (water-insoluble colorant particles) which supports the dye can be used with a dispersant as an aqueous dispersion. As the dispersant, the above-described dispersants are preferably used.

From the viewpoint of the light resistance and quality of an image, it is preferable that the ink composition according to the embodiment contain a pigment and a dispersant and it is more preferable that the ink composition contain an organic pigment and a polymeric dispersant as a water-dispersible pigment in which at least a part of surfaces of the pigment particles are coated with the polymeric dispersant. Furthermore, it is still more preferable that the ink composition contain an organic pigment and a polymeric dispersant having a carboxyl group as a water-dispersible pigment in which at least a part of surfaces of the pigment particles are coated with the polymeric dispersant having a carboxyl group. From the viewpoint of aggregability, it is preferable that the pigment be a water-insoluble pigment which is coated with a polymeric dispersant having a carboxyl group.

The average particle size of the pigment in the dispersion state is preferably 10 nm to 200 nm, more preferably 10 nm to 150 nm, and still more preferably 10 nm to 100 nm

When the average particle size is less than or equal to 200 nm, color reproduction is improved and application characteristics when ink droplets are applied with an ink jet method are improved. When the average particle size is greater than or equal to 10 nm, light resistance is improved. In addition, the particle size distribution of the colorant is not particularly limited, and may be a wide particle size distribution or a monodisperse particle size distribution. In addition, a colorant having a monodisperse particle size distribution may be used as a mixture of two or more kinds. The average particle size of the pigment in the dispersion state represents a value in a state where the ink is prepared (liquid ink is prepared). However, the same shall be applied to a so-called concentrated ink dispersion which is the previous state to the state where the ink is prepared (liquid ink is prepared).

The average particle size of the pigment in the dispersion state and the average particle size and particle size distribution of the polymer particles can be obtained by measuring the volume average particle size according to a dynamic light scattering method using a Nanotrac particle size distribution analyzer UPA-EX150 (manufactured by Nikkiso Co., Ltd.).

As the pigment, one kind may be used alone, or two or more kinds may be used in a combination.

The content of the pigment in the ink composition is preferably 1% by mass to 25% by mass and more preferably 2% by mass to 15% by mass with respect to the total mass of the ink composition, from the viewpoint of image density.

Polyvalent (meth)acrylamide

The ink composition according to the embodiment contains one kind or two or more kinds of polyvalent (meth)acrylamide compounds represented by the following formula (1) as at least one kind of a water-soluble polymerizable compound. This polyvalent (meth)acrylamide compound has a polymerizable group and plural (meth)acrylamide structures in the molecules and is a compound which is polymerizable by the irradiation of active energy rays. A polyvalent (meth)acrylamide in which n≧2 in the following formula (1) has high polymerizability and polymerization efficiency when an image is cured by the irradiation of active energy rays. As a result, when an image is formed, wear resistance and scratch resistance are improved.

“Water-soluble” described herein represents being able to dissolve in water at a given concentration or higher. In the embodiment, the polymerizable compound only needs to have a solubility in a water-based ink or, possibly, in the treatment solution. Specifically, the solubility thereof in water is preferably greater than or equal to 10% by mass and more preferably greater than or equal to 15% by mass.

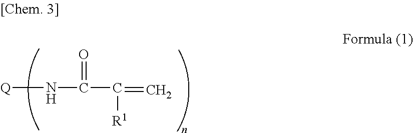

In the compound represented by the formula (1), an unsaturated vinyl monomer is bonded to a group Q through an amide bond. In the formula (1), Q represents an n-valent linking group; R¹ represents a hydrogen atom or a methyl group; and n represents an integer of 2 or more.

The R¹ represents a hydrogen atom or a methyl group, and preferably represents a hydrogen atom.

The valence n of the linking group Q is higher or equal to 2, preferably 2 to 6, and more preferably 2 to 4, from the viewpoints of improving permeability, polymerization efficiency, and ink discharge stability.

Specific examples of the linking group Q include a substituted or unsubstituted alkylene group having 4 or less carbon atoms such as a methylene, ethylene, propylene, or butylene group; a divalent or higher valent linking group having a saturated or unsaturated hetero ring (such as a pyridine ring, an imidazole ring, a pyrazine ring, a piperidine ring, a pieprazine ring, or a morpholine ring); a divalent or higher valent residue of a polyol compound having an oxyalkylene group (preferably, an oxyethylene group); and a divalent or higher valent residue of a polyol compound having three or more oxyalkylene groups (preferably, oxyethylene groups).

Specific examples of (meth)acrylamide having (meth)acrylamide structures in the molecules are shown below. However, the embodiment is not limited thereto.

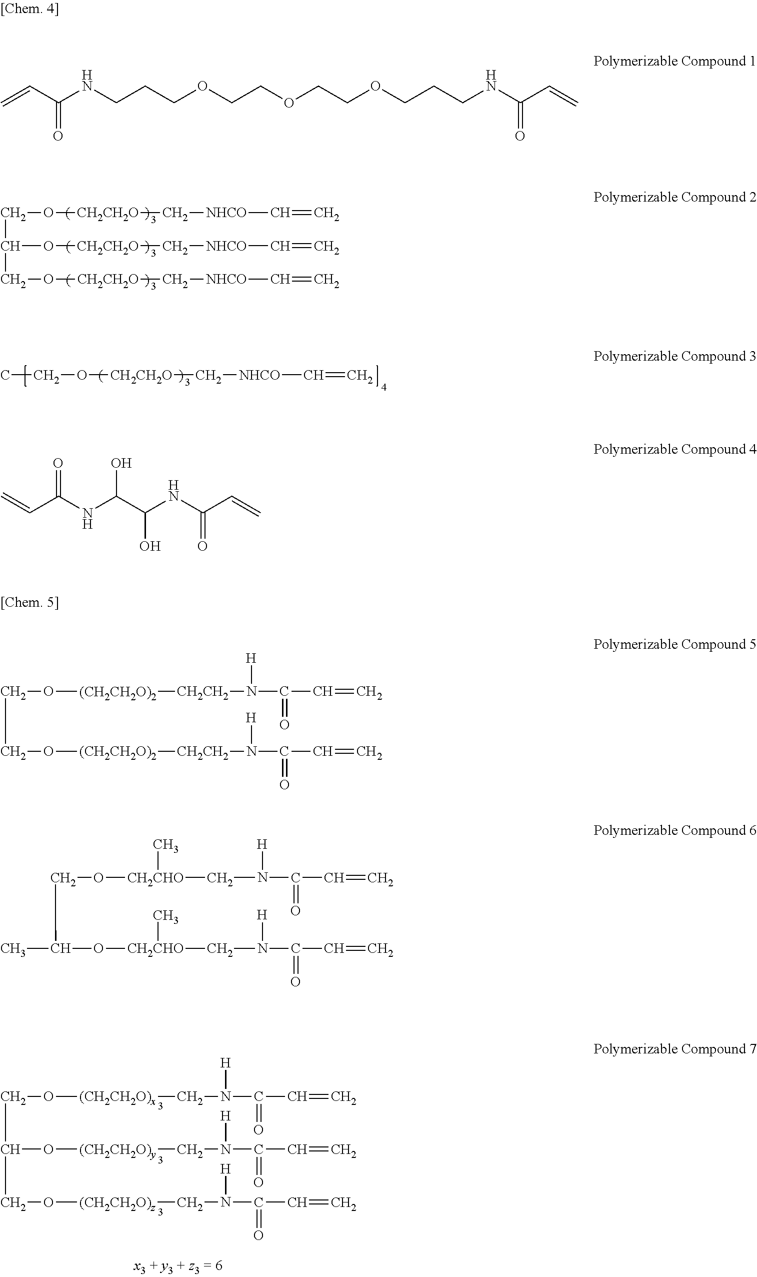

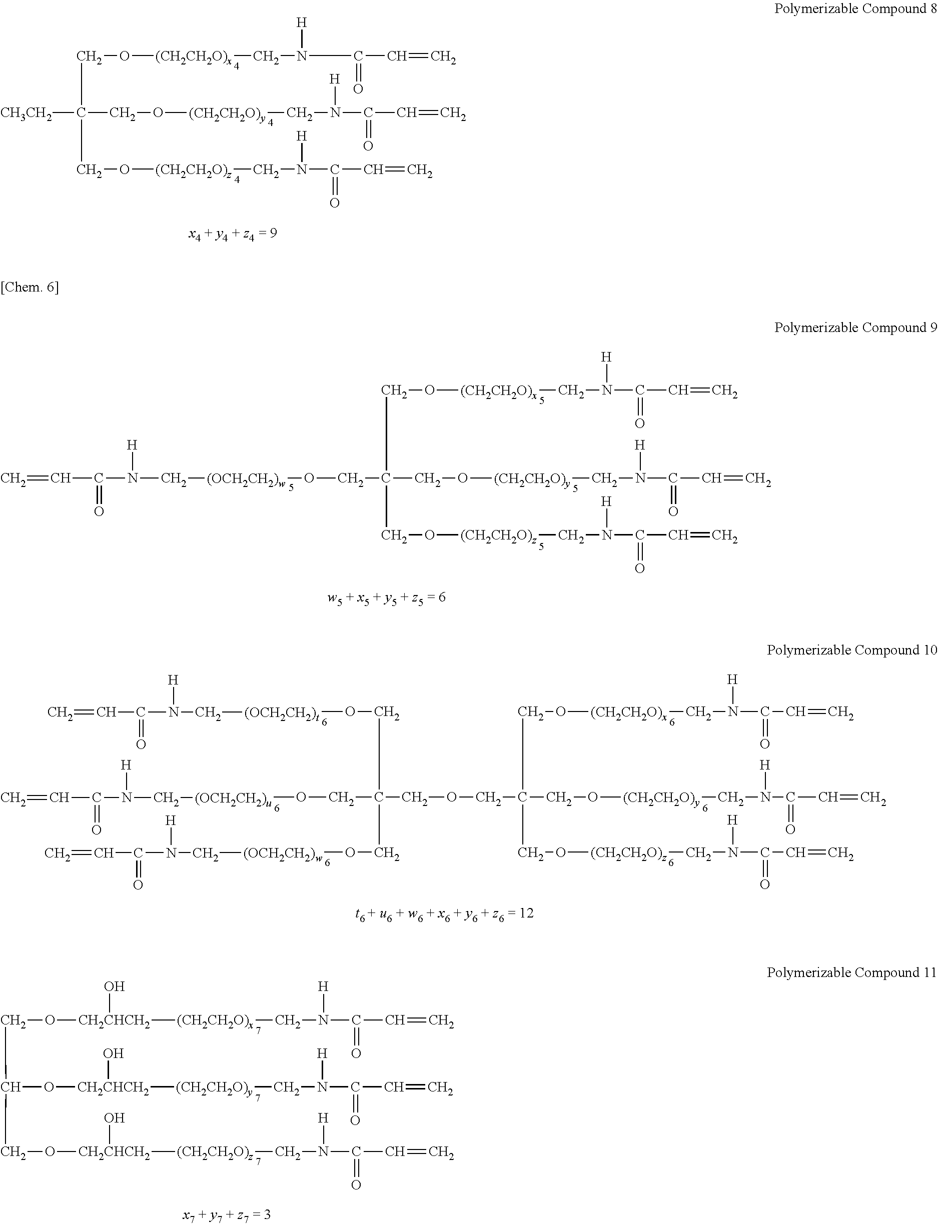

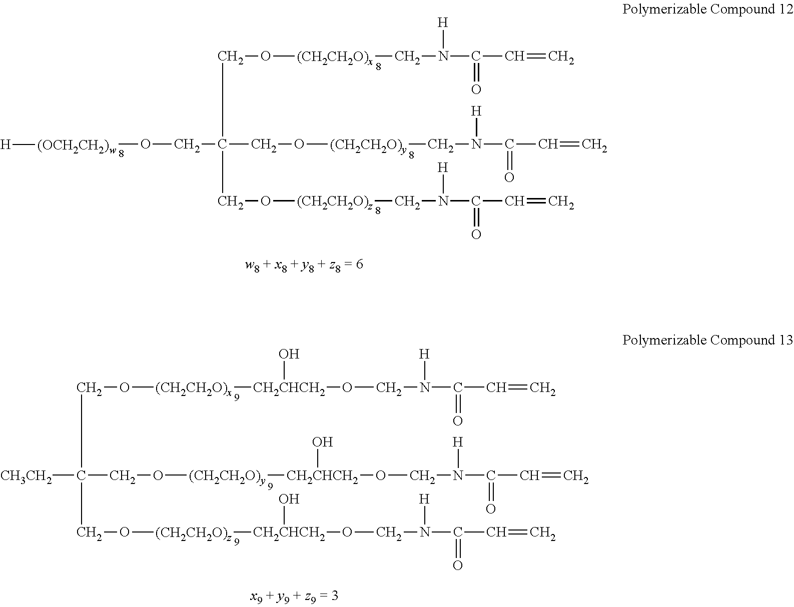

Furthermore, as the polyvalent (meth)acrylamide compound, a compound represented by the following formula (2) is preferable from the viewpoint that it has high polymerizability and curability. This compound has four acrylamide groups or methacrylamide groups as polymerizable groups in the molecules. In addition, this compound shows curability based on polymerization by the irradiation of active energy rays such as α-rays, γ-rays, X-rays, ultraviolet rays, visible light rays, infrared rays, or electron rays or by the application of energy such as heat. The compound represented by the following formula (2) shows solubility in water and satisfactorily dissolves in a water-soluble organic solvent such as water or alcohol.

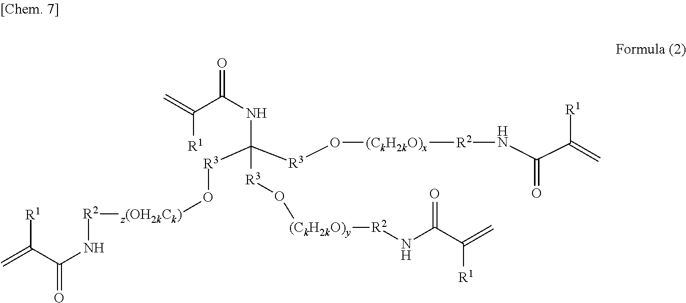

In the formula (2), R¹ represents a hydrogen atom or a methyl group and preferably represents a hydrogen atom. Each R¹ may be the same as or different from every other R¹. R² represents a linear or branched alkylene group having 2 to 4 carbon atoms. Each R² may be the same as or different from every other R². R² preferably represents an alkylene group having 3 or 4 carbon atoms, more preferably an alkylene group having 3 carbon atoms, and still more preferably a linear alkylene group having 3 carbon atoms. The alkylene group represented by R² may further have a substituent. Examples of the substituent include an aryl group or an alkoxy group.

In this case, a structure in which an oxygen atom and a nitrogen atom, bonded to both terminals of R², are bonded to the same carbon atom of R² is not adopted. R² represents a linear or branched alkylene group which links an oxygen atom and a nitrogen atom of a (meth)acrylamide group to each other. When an alkylene group has a branched structure, an —O—C—N— structure (hemiaminal structure) in which an oxygen atom and a nitrogen atom of a (meth)acrylamide group at both terminals are bonded to the same carbon atom of the alkylene group is considered to be adopted. However, the compound represented by the formula (2) does not contain a compound having such a structure. A compound which has a —O—C—N structure in the molecules is not preferable from the viewpoints that cracking is likely to occur at a carbon atom portion, that cracking is likely to occur during preservation, and that the compound causes a deterioration in preservation stability when being included in the ink composition.

R³ represents a divalent linking group, and each R³ may be the same as or different from every other R³. Examples of the divalent linking group represented by R³ include an alkylene group, an arylene group, a heterocyclic group, and a combination group thereof, and an alkylene group is preferable. When the divalent linking group contains an alkylene group, the alkylene group may further contain at least one kind of group selected from —O—, —S—, and —NR^{a}—. R^{a} represents a hydrogen atom or an alkyl group having 1 to 4 carbon atoms.

When R³ contains an alkylene group, examples of the alkylene group include a methylene group, an ethylene group, a propylene group, a butylene group, a pentylene group, a hexylene group, a heptylene group, an octylene group, and a nonylene group. The number of carbon atoms of the alkylene group of R³ is preferably 1 to 6, more preferably 1 to 3, and still more preferably 1. The alkylene group of R³ may further contain at least one kind of group selected from —O—, —S—, and —NR^{a}—. Examples of the alkylene group containing —O— include —C₂H₄—O—C₂H₄— and —C₃H₆—O—C₃H₆—. The alkylene group of R³ may further contain a substituent. Examples of the substituent include an aryl group and an alkoxy group.

When R³ contains an arylene group, examples of the arylene group include a phenylene group and a naphthylene group. The number of carbon atoms of the arylene group of R³ is preferably 6 to 14, more preferably 6 to 10, and still more preferably 6. The arylene group of R³ may further contain a substituent. Examples of the substituent include an alkyl group and an alkoxy group.

When R³ contains a heterocyclic group, a 5-membered or 6-membered heterocyclic ring is preferable as the heterocyclic group and may be further condensed. In addition, the heterocyclic group may be an aromatic heterocyclic ring or a non-aromatic heterocyclic ring. Examples of the heterocyclic group include pyridine, pyrazine, pyrimidine, pyridazine, triazine, quinoline, isoquinoline, quinazoline, cinnoline, phthalazine, quinoxaline, pyrrole, indole, furan, benzofuran, thiophene, benzothiophene, pyrazole, imidazole, benzimidazole, triazole, oxazole, benzoxazole, thiazole, benzothiazole, isothiazole, benzisothiazole, thiadiazole, isoxazole, benzisoxazole, pyrrolidine, piperidine, piperazine, imidazolidine, and thiazoline. Among these, aromatic heterocyclic groups are preferable, for example, pyridine, pyrazine, pyrimidine, pyridazine, triazine, pyrazole, imidazole, benzimidazole, triazole, thiazole, benzothiazole, isothiazole, benzisothiazole, and thiadiazole. The above-described examples of the heterocyclic group are shown in a state where the substitution positions thereof are not shown, but the substitution positions are not limited. For example, pyridine can be substituted at the 2-position, 3-position, or 4-position and can contain all these substituents.

The heterocyclic group may further contain a substituent, and examples of the substituent include an alkyl group, an aryl group, and an alkoxy group.

In the formula (2), k represents 2 or 3. Each k may be the same as or different from every other k. In addition, CₖH₂ₖ may have a linear structure or a branched structure.

In addition, x, y, and z each independently represent an integer of 0 to 6, and preferably an integer of 0 to 5 and more preferably an integer of 0 to 3. A value of x+y+z satisfies an integer of 0 to 18, preferably an integer of 0 to 15, and more preferably an integer of 0 to 9.

Among the above-described cases, a case is preferable in which R¹ represents a hydrogen atom or a methyl group; R² represents an alkylene group having 3 or 4 carbon atoms; R³ represents an alkylene group having 1 to 6 (preferably 1 to 3) carbon atoms; k represents 2 or 3; x, y, and z each independently represent an integer of 0 to 6; and a value of x+y+z satisfies an integer of 0 to 15.

Specific examples of the compound represented by the formula (2) are shown below. However, the compound is not limited thereto.

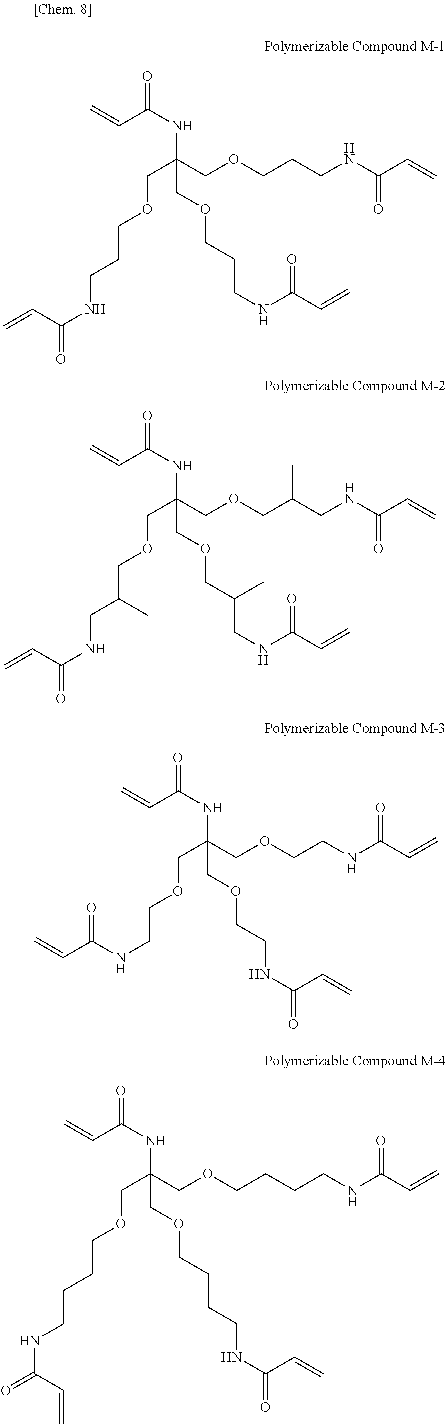

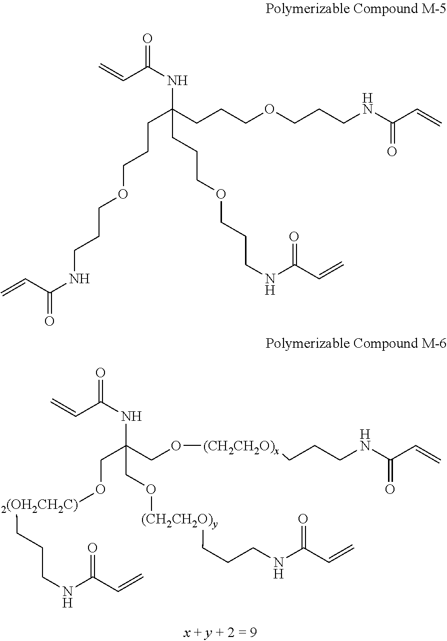

The compound represented by the formula (2) can be prepared according to the following scheme 1 or scheme 2.

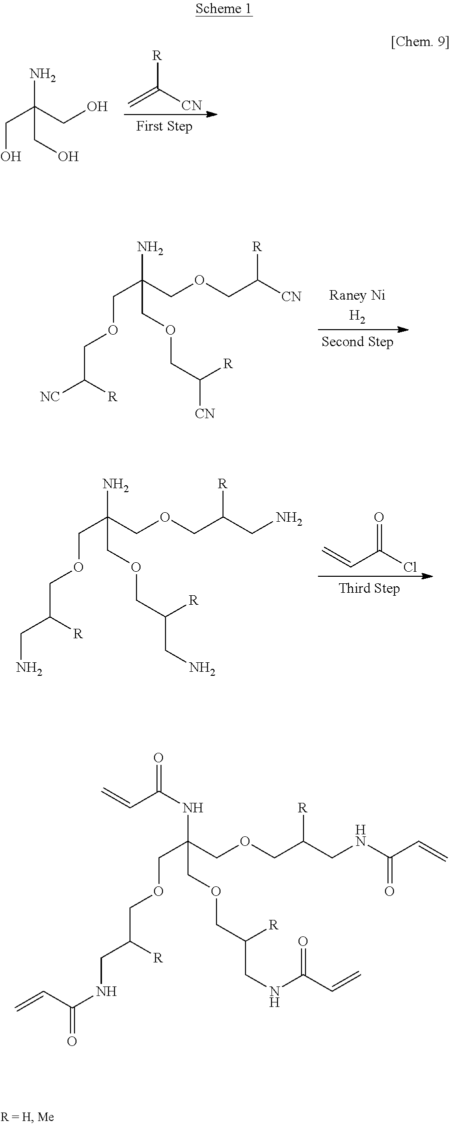

In the scheme 1, the first step is a step in which a polycyano compound is obtained by a reaction of acrylonitrile and tris hydroxymethyl amino-methane. It is preferable that the reaction in this step be performed at 3° C. to 60° C. for 2 hours to 8 hours.

The second step is a step in which the polycyano compound is caused to react with hydrogen in the presence of a catalyst and a polyamine compound is obtained by reduction. It is preferable that the reaction in this step be performed at 20° C. to 60° C. for 5 hours to 16 hours.

The third step is a step in which a polyfunctional acrylamide compound is obtained by an acylation reaction of the polyamine compound and acrylic acid chloride or methacrylic acid chloride. It is preferable that the reaction in this step be performed at 3° C. to 25° C. for 1 hour to 5 hours. Diacrylic anhydride or dimethacrylic anhydride may be used as the acrylating agent instead of acid chloride. By using both acrylic acid chloride and methacrylic acid chloride in the acylation reaction, a compound having an acrylamide group and a methacrylamide group in the same molecule can be obtained as a final product.

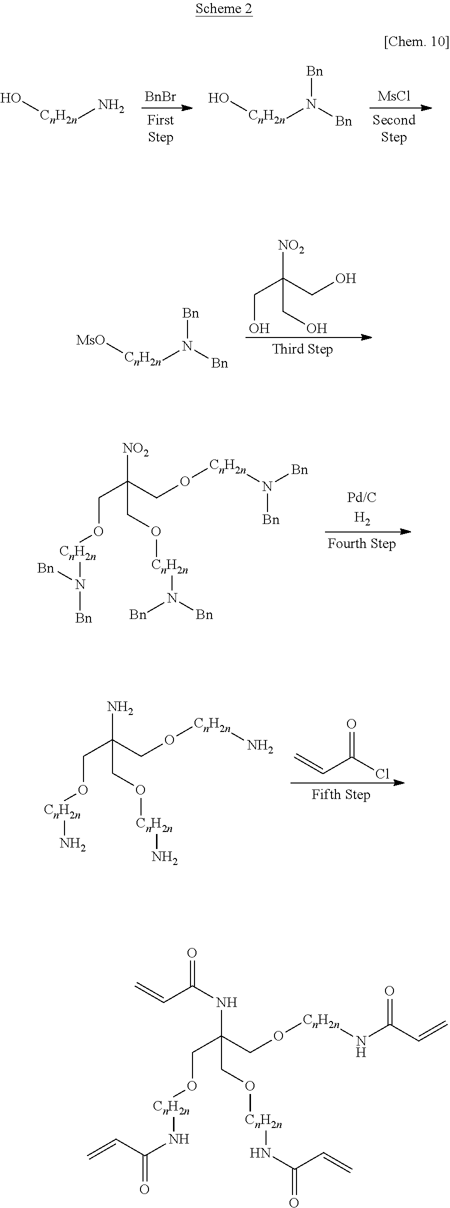

In the scheme 2, the first step is a step in which a nitrogen-protecting aminoalcohol compound is obtained by a protective group introducing reaction of a nitrogen atom of an aminoalcohol with a benzyl group, a benzyloxycarbonyl group, or the like. It is preferable that the reaction in this step be performed at 3° C. to 25° C. for 3 hours to 5 hours.

The second step is a step in which a sulfonyl compound is obtained by introducing a leaving group such as a methanesulfonyl group, a p-toluenesulfonyl group, or the like into an OH group of the nitrogen-protecting aminoalcohol compound. It is preferable that the reaction in this step be performed at 3° C. to 25° C. for 2 hours to 5 hours.

The third step is a step in which an aminoalcohol adduct is obtained by an SN2 reaction of the sulfonyl compound with tris hydroxymethyl nitromethane. It is preferable that the reaction in this step be performed at 3° C. to 70° C. for 5 hours to 10 hours.

The fourth step is a step in which the aminoalcohol adduct is caused to react with hydrogen in the presence of a catalyst and a polyamine compound is obtained by a hydrogenation reaction. It is preferable that the reaction in this step be performed at 20° C. to 60° C. for 5 hours to 16 hours.

The fifth step is a step in which a polyfunctional acrylamide compound is obtained by an acylation reaction of the polyamine compound and acrylic acid chloride or methacrylic acid chloride. It is preferable that the reaction in this step be performed at 3° C. to 25° C. for 1 hour to 5 hours. Diacrylic anhydride or dimethacrylic anhydride may be used as the acrylating agent instead of acid chloride. By using both acrylic acid chloride and methacrylic acid chloride in the acylation reaction, a compound having an acrylamide group and a methacrylamide group in the same molecule can be obtained as a final product.

A compound obtained in the above-described steps can be prepared from a reaction solution with an ordinary method. For example, the compound can be prepared with liquid separation extraction using an organic solvent, crystallization using a poor solvent, or column chromatography using silica gel.

The content of the polyvalent (meth)acrylamide in the ink composition is preferably 5% by mass to 15% by mass, more preferably 5% by mass to 14% by mass, and still more preferably 5% by mass to 13% by mass, with respect to the total amount of the ink composition. When the content of the polyvalent (meth)acrylamide is less than 5% by mass, curing reactivity is insufficient and curing is not uniformly performed over the entire image. Therefore, dots which form an image are likely to be deviated, the color reproduction of an image deteriorates, and streak defects are also not suppressed. In addition, when the content of the polyvalent (meth)acrylamide is greater than 15% by mass, curing reactivity is not uniform over the entire image, the color reproduction of the image deteriorates, and streak defects are also not suppressed.

In the embodiment, it is preferable that the above-described polyvalent (meth)acrylamide be used in combination with a monofunctional (meth)acrylamide. By adding the monofunctional (meth)acrylamide, an ink having superior permeability to a pigment layer of coated paper can be obtained. As a result, the pigment layer is cured in addition to an image and thus the adhesion is further improved.

Examples of the monofunctional (meth)acrylamide include a compound represented by the formula (1) in which n=1. When n=1, the group Q may be a monovalent group which can be linked to a (meth)acrylamide structure. When n=1, the group Q is preferably a water-soluble group. Specific examples thereof include a monovalent residue of a compound selected from the following compound group X from which one or more hydrogen atoms or a hydroxyl group is excluded.

Compound X: polyol compounds such as ethylene glycol, diethylene glycol, triethylene glycol, polyethylene glycol, propylene glycol, dipropylene glycol, tripropylene glycol, polypropylene glycol, 1,3-propanediol, 1,2-butanediol, 1,3-butanediol, 1,4-butanediol, 2,3-butanediol, 1,5-pentanediol, 1,4-pentanediol, 2,4-pentanediol, 3-methyl-1,5-pentanediol, 2-methyl-2,4-pentanediol, 1,5-hexanediol, 1,6-hexanediol, 2,5-hexanediol, glycerin, 1,2,4-butanetriol, 1,2,6-hexanetriol, 1,2,5-pentanetriol, thioglycol, trimethylolpropane, ditrimethylolpropane, trimethylolethane, ditrimethylolethane, neopentylglycol, pentaerythritol, dipentaerythritol, condensates thereof, low-molecular-weight polyvinyl alcohols, and sugars; and polyamine compounds such as ethylenediamine, diethylenetriamine, triethylenetetramine, polyethyleneimine, and polypropylenediamine.

Examples of the monofunctional (meth)acrylamide include the following compounds.

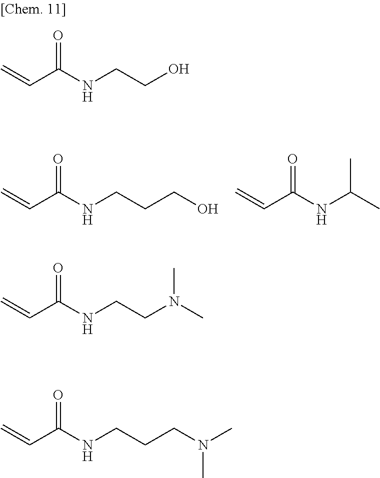

Furthermore, the polyvalent (meth)acrylamide may be used in combination with a cationic polymerizable compound. The cationic polymerizable compound is a compound having a cationic group and a polymerizable group such as an unsaturated double bond. For example, epoxy monomers or oxetane monomers can be preferably used. When the cationic polymerizable compound is added, a cationic property of the ink composition is strengthened by a cationic group and color mixing in the case of using an anionic ink is more efficiently prevented.

Polymerization Initiator

The ink composition according to the embodiment can contain at least one kind of polymerization initiator, which initiates the polymerization of polymerizable compounds with active energy rays, with or without being included in the treatment solution described below. The polymerization initiator can be used alone or as a mixture of two or more kinds thereof, or may be used in combination with a sensitizer.

The polymerization initiator can be appropriately selected among compounds which can initiate the polymerization of polymerizable compounds with active energy rays. Examples of the polymerization initiator include polymerization initiators (for example, light polymerization initiators) which form active species (for example, radicals, acids, or bases) with radioactive rays, light rays, or electron rays.

Examples of the light polymerization initiators include acetophenone, 2,2-diethoxyacetophenone, p-dimethylamino acetophenone, p-dimethylamino propiophenone, benzophenone, 2-chlorobenzophenone, p,p′-dichlorobenzophenone, p,p′-bis(dimethylamino)benzophenone, Michler's ketone, benzil, benzoin, benzoin methyl ether, benzoin ethyl ether, benzoin isopropyl ether, benzoin n-propyl ether, benzoin isobutyl ether, benzoin n-butyl ether, benzyl dimethyl ketal, tetramethylthiuram monosulfide, thioxanthone, 2-chlorothioxanthone, 2-methylthioxanthone, azobisisobutyronitrile, benzoin peroxide, di-tert-butyl peroxide, 1-hydroxycyclohexyl phenyl ketone, 1-[4-(2-hydroxyethoxy)-phenyl]-2-hydroxy-2-methyl-1-propan-1-one, 2-hydroxy-2-methyl-1-phenyl-1-one, 1-(4-isopropylphenyl)-2-hydroxy-2-methylpropane-1-one, and methyl benzoyl formate. Furthermore, examples thereof include aromatic diazonium salts, aromatic halonium salts, aromatic sulfonium salts, and metallocene compounds, for example, triphenyl sulfonium hexafluorophosphate and diphenyl iodonium hexafluoroantimonate. Among these, 1-[4-(2-hydroxyethoxy)-phenyl]-2-hydroxy-2-methyl-1-propan-1-one is preferable from the viewpoints of improving compatibility in ink and reducing unevenness in brilliance.

When the ink composition contains the polymerization initiator, the content of the polymerization initiator in the ink composition is preferably 1% by mass to 40% by mass and more preferably 1% by mass to 10% by mass with respect to the polymerizable compound. When the content of the polymerization initiator is greater than or equal to 1% by mass, the wear resistance and scratch resistance of an image is further improved, which is advantageous for high-speed recording. When the content is less than or equal to 40% by mass, ink discharge stability is superior.

Examples of the sensitizer include amine-based compounds (for example, aliphatic amine, amine having an aromatic group, and piperidine); ureas (for example, allyl-based urea and o-tolyl thiourea); sulfur compounds (for example, sodium diethyl dithiophosphate, soluble salts of aromatic sulfinic acid); nitrile-based compounds (for example, N,N-di-substituted-p-aminobenzonitrile); phosphorus compounds (for example, tri-n-butylphosphine and sodium diethyl dithiophosphate); nitrogen compounds (for example, Michler's ketone, N-nitroso hydroxylamine derivatives, oxazolidine compounds, tetrahydro-1,3-oxazine compounds, condensates of formaldehyde or acetaldehyde and diamine); chloride compounds (for example, carbon tetrachloride and hexachloro ethane); polyamines as reaction products of an epoxy resin and amine; and triethanolamine triacrylate.

The sensitizer can be added within a range not impairing the effects of the embodiment.

Water

The ink composition according to the embodiment is a water-based composition containing water, and the content of water is preferably greater than or equal to 50% by mass with respect to the total amount of the ink composition. When the content of water is greater than or equal to 50% by mass, the stability of the ink composition over time can be maintained at a high level. The content of water is preferably 50% by mass to 80% by mass, more preferably 50% by mass to 75% by mass, and still more preferably 50% by mass to 70% by mass.

Water-Soluble Organic Solvent

The ink composition according to the embodiment may contain a water-soluble organic solvent. When the ink composition contains a water-soluble organic solvent, it is preferable that the content thereof be small. In the embodiment, it is preferable that the content of the water-soluble organic solvent be less than 3% by mass with respect to the total mass of the ink composition.

In the embodiment, the content of the water-soluble organic solvent being less than 3% by mass represents that the ink composition contains a small amount of the water-soluble organic solvent or preferably does not contain the water-soluble organic solvent (content: 0% by mass).

The water-soluble organic solvent has effects of preventing the ink composition from being dried, wetting the ink composition, and accelerating the permeation of the ink composition into paper. Examples of a water-soluble organic solvent which may be included in the ink composition are as follows. Examples thereof include glycols such as glycerin, 1,2,6-hexanetriol, trimethylolpropane, ethylene glycol, propylene glycol, diethylene glycol, triethylene glycol, tetraethylene glycol, pentaethylene glycol, and dipropylene glycol; polyols such as alkane diols including 2-butene-1,4-diol, 2-ethyl-1,3-hexanediol, 2-methyl-2,4-pentanediol, 1,2-octanediol, 1,2-hexanediol, 1,2-pentanediol, and 4-methyl-1,2-pentanediol; sugars, sugar alcohols, hyaluronic acids, alkyl alcohols having 1 to 4 carbon atoms, glycol ethers, 2-pyrrolidone, and N-methyl-2-pyrrolidone which are described in paragraph 0116 of JP2011-42150A; and alkylene oxide adducts of glycerin which are described in paragraphs 0121 to 0125 of JP2011-42150A. Among these solvents, one kind can be used alone or two or more kinds can be appropriately selected and used. Polyols are effective as an anti-drying agent or wetting agent, and examples thereof include polyols described in paragraph 0117 of JP2011-42150A. In addition, polyol compounds are preferable as a penetrant. Examples of an aliphatic acid diol include examples described in paragraph 0117 of JP2011-42150A.

Polymer Particles

The ink composition according to the embodiment can contain at least one kind of polymer particles. The polymer particles has a function of fixing the ink composition in which, when being in contact with a treatment solution described below or with a region where the treatment solution is dried, the dispersion thereof in the ink composition is unstable, the polymer particles aggregate, and thus the viscosity of the ink composition is increased. As a result, the adhesion of the ink composition with a recording medium and the scratch resistance of an image can be further improved.

In addition, it is preferable that the ink composition according to the embodiment contain polymer particles from the viewpoint of the aggregation rate and the brilliance of a formed image when the treatment solution described below is used for forming an image. When the ink composition contains polymer particles, the content (in terms of solid concentration) of the polymer particles can be appropriately selected within a range of 1% by mass to 30% by mass with respect to the ink composition. The content of the polymer particles is preferably 1% by mass to 10% by mass and more preferably 1% by mass to 5% by mass, from the viewpoints of satisfactorily maintaining the ink discharge property while improving the wear resistance and scratch resistance of an image. As the polymer particles, one kind can be used alone or a mixture of two or more kinds thereof can be used.

The polymer particles can be used as a latex in which polymer particles are dispersed in an aqueous medium. Examples of the polymer include acrylic resins, vinyl acetate-based resins, styrene-butadiene-based resins, vinyl chloride-based resins, acryl-styrene-based resins, butadiene-based resins, styrene-based resins, cross-linked acrylic resins, cross-linked styrene-based resins, benzoguanamine resins, phenol resins, silicone resins, epoxy resins, urethane-based resins, paraffin-based resins, and fluororesins. Among these, preferable examples include acrylic resins, acryl-styrene-based resins, styrene-based resins, cross-linked acrylic resins, and cross-linked styrene-based resins.

The above-described aqueous medium contains water and optionally may further contain a hydrophilic organic solvent. In the embodiment, it is preferable that the aqueous medium contain water and 0.2% by mass or less of hydrophilic organic solvent with respect to water and it is more preferable that the aqueous medium contain only water.

Among polymer particles, self-dispersible polymer particles are preferable. The self-dispersible polymer particles represent particles of a water-insoluble polymer which does not contain a free emulsifier and can be dispersed in an aqueous medium by a functional group (in particular, an acidic group or a salt thereof) included in the polymer particles when the dispersion is performed in the absence of a surfactant (in particular, when the dispersion is performed with a phase-transfer emulsification method). The self-dispersible polymer particles are preferable from the viewpoint of discharge stability and liquid stability (in particular, dispersion stability) of the ink composition containing a pigment.

In this case, the dispersion state includes both an emulsion state in which the water-insoluble polymer particles in the liquid state are emulsified in the aqueous medium and a suspension state in which the water-insoluble polymer particles in the solid state is suspended in the aqueous medium. It is preferable that the water-insoluble polymer particles according to the embodiment be in the suspension state where the water-insoluble polymer particles in the solid state are suspended in the aqueous medium, from the viewpoint of the aggregation rate and a fixing property when being in contact with a liquid composition.

Examples of a method of emulsifying or suspending the self-dispersible polymer particles, that is, examples of a method of preparing an aqueous dispersion of the self-dispersible polymer particles include a phase-transfer emulsification method. Examples of the phase-transfer emulsification method include a method in which the self-dispersible polymer particles are dissolved or dispersed in a solvent (for example, a hydrophilic organic solvent); the resultant is poured into water without adding a surfactant to neutralize a salt-producing group (for example, an acidic group) included in the self-dispersible polymer particles, followed by stirring and mixing; the solvent is removed; and as a result, an aqueous dispersion in the emulsion or suspension state is obtained.

The dispersion state of the self-dispersible polymer particles is a state in which, when a solution which is obtained by dissolving 30 g of water-insoluble polymer particles in 70 g of organic solvent (for example, methyl ethyl ketone), a neutralizer (when a salt-producing group is anionic, sodium hydroxide; when a salt-producing group is cationic, acetic acid) which can completely neutralize a salt-producing group of the water-insoluble polymer particles, and 200 g of water are mixed and stirred (device: stirrer equipped with a stirring blade; rotating speed: 200 rpm; 30 minutes; 25° C.), the dispersion state is visually and stably observed at 25° C. for at least 1 week even after the removal of the organic solvent from the mixed solution.

In addition, the water-insoluble polymer represents a polymer which has a dissolution amount of 10 g or less when being dried at 105° C. for 2 hours and dissolved in 100 g of water at 25° C. The dissolution amount is preferably less than or equal to 5 g and more preferably less than or equal to 1 g. The dissolution amount described herein is a value when a salt-producing group of the water-insoluble polymer is completely neutralized by using sodium hydroxide or acetic acid according to the kind of the salt-producing group.

The details of the self-dispersible polymer particles used in the embodiment can be found in paragraphs 0066 to 0113 of JP2011-042150A, and the description can be applied to the embodiment.

It is preferable that the self-dispersible polymer particles according to the embodiment contain water-insoluble polymer particles having a hydrophilic constitutional unit and a constitutional unit derived from an aromatic group-containing monomer from the viewpoint of self-dispersibility.

The hydrophilic constitutional unit is not particularly limited as long as it is a repeating unit derived from a hydrophilic group-containing monomer. As the hydrophilic group-containing monomer, a dissociable group-containing monomer is preferable and a dissociable group-containing monomer having an ethylenic unsaturated bond with the dissociable group is more preferable from the viewpoint of self-dispersibility and aggregability. Examples of the dissociable group-containing monomer include unsaturated carboxylic acid monomers, unsaturated sulfonic acid monomers, and unsaturated phosphoric acid monomers. Specific examples of the unsaturated carboxylic acid monomers include acrylic acid, methacrylic acid, crotonic acid, itaconic acid, maleic acid, fumaric acid, citraconic acid, and 2-methacryloyloxymethyl succinic acid. Among the dissociable group-containing monomers, unsaturated carboxylic acid monomers are preferable, acrylic monomers are more preferable, and acrylic acid and methacrylic acid are still more preferable, from the viewpoints of dispersion stability and ink discharge stability.

The aromatic group-containing monomer is not particularly limited as long as it is a compound having an aromatic group and a polymerizable group. It is preferable that the aromatic group-containing monomer be a monomer having an aromatic group derived from an aromatic hydrocarbon and an ethylenic unsaturated bond. Examples thereof include phenoxyethyl(meth)acrylate, benzyl(meth)acrylate, phenyl(meth)acrylate, and styrene-based monomers. Among these, from the viewpoint of the balance between hydrophilicity and hydrophobicity of a polymer chain and an ink fixing property, aromatic group-containing (meth)acrylate monomers is preferable, at least one kind selected from phenoxyethyl(meth)acrylate, benzyl(meth)acrylate, and phenyl(meth)acrylate is more preferable, and phenoxyethyl(meth)acrylate or benzyl(meth)acrylate is still more preferable.

The acid value of the self-dispersible polymer particles is preferably 25 mgKOH/g to 100 mgKOH/g and more preferably 30 mgKOH/g to 70 mgKOH/g, from the viewpoints of improving aggregability when being in contact with the treatment solution. When the acid value is greater than or equal to 25 mgKOH/g, stable self-dispersibility is obtained. It is more preferable that the self-dispersible polymer particles contain a carboxyl group and polymer particles having an acid value within the above-described range, from the viewpoints of self-dispersibility and aggregability when being in contact with the treatment solution.

Regarding the molecular weight of the water-insoluble polymer constituting the self-dispersible polymer particles, the weight average molecular weight thereof is preferably 3,000 to 200,000, more preferably 5,000 to 150,000, and still more preferably 10,000 to 100,000. When the weight average molecular weight is greater than or equal to 3000, the amount of water-soluble components can be effectively suppressed. In addition, when the weight average molecular weight is less than or equal to 200,000, self-dispersion stability can increase.

The weight average molecular weight described herein is measured using gel permeation chromatography (GPC). HLC-8220GPC (manufactured by Tosoh Corporation) is used as high-speed GPC equipment; TSKgeL Super HZM-H, TSKgeL Super HZ4000, and TSKgeL Super HZ2000 (manufactured by Tosoh Corporation, 4.6 mmID×15 cm) are used as columns; and tetrahydrofuran (THF) is used as an eluent.

From the viewpoints of controls of hydrophobicity and hydrophilicity of the polymer, it is preferable that the water-insoluble polymer constituting the self-dispersible polymer particles contain 15% by mass to 80% by mass (in terms of copolymerization ratio) of a constitutional unit derived from an aromatic group-containing (meth)acrylate monomer (preferably, a constitutional unit derived from a phenoxyethyl(meth)acrylate monomer and/or a constitutional unit derived from a benzyl(meth)acrylate monomer) with respect to the total mass of the water-insoluble polymer particles.

In addition, from the viewpoints of control of hydrophobicity and hydrophilicity of the polymer, it is preferable that the water-insoluble polymer contain 15% by mass to 80% by mass (in terms of copolymerization ratio) of a constitutional unit derived from an aromatic group-containing (meth)acrylate monomer with respect to the total mass of the water-insoluble polymer particles, a constitutional unit derived from a carboxyl group-containing monomer, and a constitutional unit derived from an alkyl group-containing monomer (preferably, a constitutional unit derived from an alkyl ester of (meth)acrylic acid), and it is more preferable that the water-insoluble polymer contain 15% by mass to 80% by mass (in terms of copolymerization ratio) of a constitutional unit derived from phenoxyethyl(meth)acrylate and/or a constitutional unit derived from benzyl(meth)acrylate with respect to the total mass of the water-insoluble polymer particles, a constitutional unit derived from a carboxyl group-containing monomer, and a constitutional unit derived from an alkyl group-containing monomer (preferably, a constitutional unit derived from an alkyl ester of (meth)acrylic acid having 1 to 4 carbon atoms). Furthermore, it is still more preferable that the acid value of the water-insoluble polymer be 25 mgKOH/g to 95 mgKOH/g and the weight average molecular weight be 5,000 to 150,000.

Specific examples of the water-insoluble polymer constituting the self-dispersible polymer particles include phenoxyethyl acrylate/methyl methacrylate/acrylic acid copolymer (50/45/5), phenoxyethyl acrylate/benzyl methacrylate/isobutyl methacrylate/methacrylic acid copolymer (30/35/29/6), phenoxyethyl methacrylate/isobutyl methacrylate/methacrylic acid copolymer (50/44/6), phenoxyethyl acrylate/methyl methacrylate/ethylacrylate/acrylic acid copolymer (30/55/10/5), benzyl methacrylate/isobutyl methacrylate/methacrylic acid copolymer (35/59/6), styrene/phenoxyethyl acrylate/methyl methacrylate/acrylic acid copolymer (10/50/35/5), benzyl acrylate/methyl methacrylate/acrylic acid copolymer (55/40/5), phenoxyethyl methacrylate/benzyl acrylate/methacrylic acid copolymer(45/47/8), styrene/phenoxyethyl acrylate/butyl methacrylate/acrylic acid copolymer (5/48/40/7), benzyl methacrylate/isobutyl methacrylate/cyclohexyl methacrylate/methacrylic acid copolymer (35/30/30/5), phenoxyethyl acrylate/methyl methacrylate/butyl acrylate/methacrylic acid copolymer (12/50/30/8), benzyl acrylate/isobutyl methacrylate/acrylic acid copolymer (93/2/5), styrene/phenoxyethyl methacrylate/butyl acrylate/acrylic acid copolymer (50/5/20/25), styrene/butyl acrylate/acrylic acid copolymer (62/35/3), methyl methacrylate/phenoxyethyl acrylate/acrylic acid copolymer (45/51/4), methyl methacrylate/phenoxyethyl acrylate/acrylic acid copolymer (45/49/6), methyl methacrylate/phenoxyethyl acrylate/acrylic acid copolymer (45/48/7), methyl methacrylate/phenoxyethyl acrylate/acrylic acid copolymer (45/47/8), and methyl methacrylate/phenoxyethyl acrylate/acrylic acid copolymer (45/45/10). Numerical values in the brackets indicate mass ratios of copolymerization components.

The volume average particle size of the polymer particles is preferably in a range of 1 nm to 70 nm, and the particle size distribution thereof may be a wide particle size distribution or a monodisperse particle size distribution. The volume average particle size and the particle size distribution can be measured according to a dynamic light scattering method using a Nanotrac particle size distribution analyzer UPA-EX150 (manufactured by Nikkiso Co., Ltd.).

In addition, the glass transition temperature (Tg) of the self-dispersible polymer particles is preferably higher than or equal to 70° C., more preferably higher than or equal to 80° C., and still more preferably higher than or equal to 100° C. When the Tg is higher than or equal to 70° C., local blocking resistance can be improved.

Other Components

The ink composition according to the embodiment can contain other additives in addition to the above-described components. Examples of other additives include well-known additives such as a polymerization inhibitor, an anti-drying agent (wetting agent), an anti-fading agent, an emulsion stabilizer, a permeation accelerator, an ultraviolet absorber, a preservative, an antifungal agent, a pH regulator, a surface tension regulator, a defoaming agent, a viscosity adjusting agent, a dispersion stabilizer, an anti-rust agent, and a chelating agent. In the case of an ink composition, these various kinds of additives are directly added to the ink composition. Generally, when an oil dye is used as a dispersion, a dye dispersion is prepared and then the additives are added to the dispersion. However, the additives may be added to an oil phase or a water phase during the preparation.

Treatment Solution Application Step

In addition to the ink application step, it is preferable that the image forming method according to the embodiment include a treatment solution application step of applying a treatment solution, which contains an aggregation component capable of aggregating components in the ink composition when being in contact with the ink composition, onto the recording medium. By applying the treatment solution, which aggregates components in the ink composition, onto the recording medium, a high-density and high-resolution image is easily obtained, the color reproduction of the image is further improved, and streak defects, which are likely to appear on an image formed by aggregating components in the ink composition, are also prevented.

The treatment solution, applied onto the recording medium, contacts the ink composition to form an image. In this case, the pigment and dispersed particles such as the polymer particles in the ink composition aggregate to fix an image on the recording medium.

The treatment solution can be applied onto a recording medium with a well-known method such as a coating method, an ink jet method, or a dipping method. Examples of the coating method include well-known coating methods using a direct gravure coater, an offset gravure coater, an extrusion die coater, an air doctor coater, a blade coater, a rod coater, a knife coater, a squeeze coater, a reverse roll coater, or a bar coater. The details of the ink jet method are described as above.

The treatment solution application step may be provided before or after the ink application step in which the ink composition is used. In the embodiment, it is preferable that the ink application step be provided after applying the treatment solution in the treatment solution application step. Specifically, a configuration is preferable in which the treatment solution capable of aggregating the pigment and/or the polymer particles in the ink composition is applied onto a recording medium in advance; and the ink composition is applied onto the recording medium so as to come into contact with the treatment solution applied on the recording medium; and thus, an image is formed. As a result, a drying effect is further improved, an image is formed at high speed, and an image having high density and resolution is obtained.

The application amount of the treatment solution is not particularly limited as long as the ink composition aggregates. The application amount of the aggregation component is preferably greater than or equal to 0.1 g/m² and more preferably 0.2 g/m² to 0.7 g/m². When the application amount of the aggregation component is greater than or equal to 0.1 g/m², superior high-speed aggregability can be maintained according to various forms of the ink composition. In addition, it is preferable that the application amount of the aggregation component be less than or equal to 0.7 g/m², from the viewpoint that there are no adverse effects (changes in brilliance) on surface properties of a recording medium to which the ink composition is applied.

In addition, in the embodiment, it is preferable that the ink application step be provided after the treatment solution application step; and a treatment solution heating and drying step of heating and drying the treatment solution on the recording medium until the ink composition is applied after applying the treatment solution onto the recording medium, be further provided. By heating and drying the treatment solution in advance before the ink application step, ink colorability is improved, for example, bleeding is prevented. As a result, a visible image having superior color density and hue can be formed.

The treatment solution can be heated and dried by well-known heating means such as a heater, blowing means for blowing air such as a drier, or a combination thereof. Examples of the heating method include a method of applying heat with a heater or the like from the opposite surface to a surface of a recording medium onto which the treatment solution is applied; a method of blowing warm air or hot air to a surface of a recording medium onto which the treatment solution is applied; and a heating method using an infrared heater. Heating may be performed in a combination of plural methods among the above-described methods.

### Treatment Solution

The ink composition according to the embodiment is preferably used in combination with the treatment solution, which contains the aggregation component capable of aggregating components in the ink composition and forming aggregates when being in contact with the ink composition, to be used as an ink set.

The treatment solution according to the embodiment contains at least the aggregation component capable of aggregating components in the above-described ink composition, and preferably, further contains a polymerization initiator. In addition, the treatment solution optionally further contains other components. By applying the ink composition and the treatment solution onto a recording medium to form an image, high-speed ink jet recording can be performed. In addition, even when high-speed recording is performed, an image having superior drawing properties such as density or resolution (for example, the reproduction of thin lines and fine portions) can be obtained.

As the aggregation components, any one of compounds capable of changing the pH of the ink composition, polyvalent metal salts, and cationic polymers can be used. From the viewpoints of aggregability of components in the ink composition, compounds capable of changing the pH of the ink composition are preferable, and compounds capable of lowering the pH of the ink composition are more preferable. Examples of the compounds capable of lowering the pH of the ink composition include acidic materials. Preferable examples of the acidic materials include sulfuric acid, hydrochloric acid, nitric acid, phosphoric acid, polyacrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidone carboxylic acid, pylon carboxylic acid, pyrrole carboxylic acid, furan carboxylic acid, pyridine carboxylic acid, coumaric acid, thiophene carboxylic acid, nicotinic acid, derivatives thereof, and salts thereof. Among the acidic materials, one kind may be used alone or two or more kinds may be used in combination.

When the treatment solution contains an acidic material, the pH (25° C.) of the treatment solution is preferably less than or equal to 6, more preferably less than or equal to 4, still more preferably 1 to 4, and even still more preferably 1 to 3. At this time, the pH (25° C.) of the ink composition is preferably greater than or equal to 7.5 (more preferably greater than or equal to 8.0). It is preferable that the pH (25° C.) of the ink composition be greater than or equal to 8.0 and the pH (25° C.) of the treatment solution be 0.5 to 4, from the viewpoints of image density, resolution, and high-speed ink jet recording.

As the aggregation component according to the embodiment, an acidic material having high water solubility is preferable. From the viewpoints of improving aggregability and fixing the entire ink, an organic acid is preferable, a divalent or higher valent organic acid is more preferable, and a divalent or trivalent acidic material is still more preferable. As the divalent or higher valent organic acid, an organic acid having a first pKa of 3.5 or lower is preferable and an organic acid having a first pKa of 3.0 or lower is more preferable. Specifically, preferable examples thereof include phosphoric acid, oxalic acid, malonic acid, and citric acid.

Polyvalent metal salts and cationic polymers, which can be used as the aggregation components, are described in paragraph [0155] to [0156] of JP2011-042150A, and can be applied to the embodiment.

As the aggregation component, one kind can be used alone or a mixture of two or more kinds can be used. The content of the aggregation component, which aggregate components in the ink composition, in the treatment solution is preferably 1% by mass to 50% by mass, more preferably 3% by mass to 45% by mass, and still more preferably 5% by mass to 40% by mass with respect to the total mass of the treatment solution.

The treatment solution according to the embodiment can contain at least one kind of polymerization initiator, which initiates the polymerization of polymerizable compounds in the ink composition with active energy rays, with or without being included in the ink composition. The polymerization initiator can be used alone or as a mixture of two or more kinds thereof, or may be used in combination with a sensitizer.

Similarly to the ink composition, the polymerization initiator used in the treatment solution can be appropriately selected from among compounds which can initiate the polymerization of polymerizable compounds with active energy rays. Examples of the polymerization initiator include polymerization initiators (for example, light polymerization initiators) which form active species (for example, radicals, acids, or bases) with radioactive rays, light rays, or electron rays. The details of the light polymerization initiators are the same as those in the above-described ink composition.

In the embodiment, the polymerization initiator may be included in either or both of the ink composition and the treatment solution. From the viewpoints of polymerization reactivity and curability and furthermore, of improving the adhesion and scratch resistance of an image, it is preferable that the polymerization initiator be included in at least the ink composition.

In addition, the treatment solution may further contain other additives as other components within a range not impairing the effects of the embodiment. Examples of other additives include well-known additives such as an anti-drying agent (wetting agent), an anti-fading agent, an emulsion stabilizer, a permeation accelerator, an ultraviolet absorber, a preservative, an antifungal agent, a pH regulator, a surface tension regulator, a defoaming agent, a viscosity adjusting agent, a dispersant, a dispersion stabilizer, an anti-rust agent, and a chelating agent.

Drying Step

The image forming method according to the invention can include a drying step. In the drying step, at least a part of water in an image (ink composition), which is formed on the recording medium by the applying the ink composition thereonto in the ink application step, is dried and removed. In addition, when the ink composition according to the embodiment contains a water-soluble organic solvent, at least a part of the water-soluble organic solvent is dried and removed in the drying step. The drying step is provided before a curing step described below to reduce the content of water or the water-soluble organic solvent in the ink composition. As a result, the curing reaction of a polymerizable compound in the curing step advances more smoothly. In particular, when an image is formed at a high speed, for example, when an image is formed with a single-pass method in which ink is discharged and scanning is performed once in an element arraying direction to form one line, the sensitivity required for image forming properties can be obtained.

For example, when an image is formed at a transport speed of a recording medium of 100 mm/s to 3000 mm/s, the effects of the embodiment are more significantly exhibited. Furthermore, when the transport speed is preferably 150 mm/s to 2700 mm/s and more preferably 250 mm/s to 2500 mm/s, the effects of improving the adhesion and the scratch resistance, which are obtained by providing the drying step, are further improved.

In the drying step according to the embodiment, it is not necessary that water or a water-soluble organic solvent be dried completely. Water or the water-soluble organic solvent may remain in an image or a pigment layer. In the drying step, it is rather preferable that water or a water-soluble organic solvent be dried so as to remain within a range not impairing UV curing reaction.

Drying is performed by heating means for applying heat with a heating element such as a nichrome wire heater, blowing means for blowing air such as a drier, or a combination thereof. Examples of the heating method include a method of applying heat with a heater or the like from the opposite surface to an image-formed surface of a recording medium; a method of blowing warm air or hot air to an image-formed surface of a recording medium; and a heating method using an infrared heater. Heating may be performed in a combination of plural methods among the above-described methods.

Curing Step

The image forming method according to the embodiment can include a curing step. In the curing step, after the drying step, an image on a recording medium is irradiated with active energy rays to cure the ink composition which forms an image. The polymerizable compounds in the ink composition are polymerized by the irradiation of active energy rays and thus the cured film containing a pigment is formed. As a result, the scratch resistance of the formed image is further improved.

The active energy rays are not particularly limited as long as the polymerizable compounds can be polymerized with them, and examples thereof include ultraviolet rays and electron rays. Among these, ultraviolet rays are preferable from the viewpoint of versatility. In addition, examples of a source of the active energy rays include an ultraviolet irradiation lamp (for example, a halogen lamp or a high-pressure mercury lamp), a laser, an LED, and an electron ray irradiation device.

Any well-known means may be used as the means for irradiating ultraviolet rays, but in particular, an ultraviolet ray irradiation lamp is preferable. Preferable examples of the ultraviolet ray irradiation lamp include a so-called low-pressure mercury lamp having a mercury vapor pressure of 1 Pa to 10 Pa when turned on, a high-pressure mercury lamp, a mercury lamp having a coated phosphor, and a UV-LED light source. The emission spectrum of the mercury lamp and the UV-LED light source in the ultraviolet range is preferably less than or equal to 450 nm and more preferably 184 nm to 450 nm, which is suitable for efficiently causing a reaction of polymerizable compounds in a black ink composition or a colored ink composition. In addition, such lamps are suitable because a small power source can be used when a power source is mounted onto a printer. Examples of the mercury lamps, which have been put into practice, include a metal halide lamp, a high-pressure mercury lamp, an ultrahigh-pressure mercury lamp, a xenon flash lamp, a deep UV lamp, a lamp which externally excites a mercury lamp using microwaves without electrodes, and a UV laser. These lamps have an emission wavelength range within the above-described range and thus can be basically applied as long as the size of a power source, the incident light intensity, and the shape of a lamp are compatible. The light source can be selected according to the sensitivity of a polymerization initiator to be used.

The illuminance of the active energy rays according to the embodiment is set to be 0.5 W/cm² to 2 Wcm² in an effective wavelength range for curing. When the illuminance is greater than or equal to 0.5 W cm², a high-quality image having toughness is obtained. When the illuminance is less than or equal to 2 W cm², damages to a recording medium and the fading of color materials can be prevented.

Recording Medium

In the image forming method according to the embodiment, an image is formed on a recording medium. The recording medium is not particularly limited. General printing paper such as so-called high-quality paper, coated paper, or art paper, which is generally used for offset printing and is mainly composed of cellulose, can be used as the recording medium. When an image is formed with a general ink jet method using a water-based ink on general printing paper mainly composed of cellulose, the ink is absorbed and dried at a relatively low rate, color materials easily move after the ink droplets are applied, and thus image quality easily deteriorate. However, in the image forming method according to the embodiment, the movement of color materials is suppressed and a high-quality image having superior color density and hue can be formed.

As for the recording medium, commercially available general products can be used, but a coated paper having a pigment layer on at least one surface of a support, which includes cellulose pulp as a major component, is preferable.

The above-described coated paper has a single pigment layer or multiple pigment layers on at least one surface of a support, which includes cellulose pulp as a major component. Examples thereof include a recording medium which has a transfer amount of pure water of 1 ml/m² to 15 ml/m² at a contact time of 100 ms and a transfer amount of 2 ml/m² to 20 ml/m² at a contact time of 400 ms when measured with a dynamic scanning absorptometer.

Support

As the support according to the embodiment which includes cellulose pulp as a major component, a support is used which are made of raw materials, obtained by mixing chemical pulp, mechanical pulp, and recycled pulp according to a given ratio, by a paper machine such as a fourdrinier former, a gap-type twin wire former, or a hybrid former in which the last half of a fourdrinier portion is composed of a twin wire. Optionally, an internal sizing agent, a yield improver, and a paper strong agent are added to the raw materials. “The major component” described herein represents a component having a content of 50% by mass or greater with respect to the total mass of the support.

The details of the pulp used for the support can be found in paragraph [0024] of JP2011-42150A. In addition, a filler, an internal sizing agent, or the like can be used for the support. The details of the filler and the internal sizing agent can be found in paragraphs to [0027] of JP2011-42150A.

Pigment Layer

The coated paper according to the embodiment has a single or multiple pigment layers on at least one surface of the support.

Regarding a pigment used for the pigment layer, the kind thereof is not particularly limited, and a well-known organic pigment or inorganic pigment of the related art may be used. Specific examples of the pigment can be found in paragraph [0029] of JP2011-42150A. A white inorganic pigment is preferable from the viewpoints of maintaining the transparency of a recording medium and improving image density.

The pigment layer can further contain additives such as an aqueous binder, an antioxidant, a surfactant, a defoaming agent, a foam suppressor, a pH regulator, a curing agent, a colorant, a fluorescent brightening agent, a preservative, and a water resistant additive. The details of the aqueous binder can be found in paragraph [0030] of JP2011-42150A.

A method of forming the pigment layer on the support is not particularly limited and can be appropriately selected according to the purpose. For example, base paper is coated with a dispersion in which a pigment is dispersed in water, followed by drying to form a pigment layer. The amount of the pigment in the pigment layer is preferably 0.1 g/m² to 20 g/m². When the amount of the pigment is greater than or equal to 0.1 g/m², blocking resistance is further improved. In addition, when the amount of the pigment is less than or equal to 20 g/m², there are advantages in terms of brittleness. The content of the pigment in the pigment layer is preferably greater than or equal to 10% by mass and more preferably greater than or equal to 14% by mass with respect to the total solid content of the pigment layer.

Regarding the coated paper, it is preferable that the amount of pure water transferred onto the coated paper be 1 ml/m² to 15 ml/m² at a contact time of 100 ms and be 2 ml/m² to 20 ml/m² at a contact time of 400 ms when measured with a dynamic scanning absorptometer. That is, in the embodiment, an image in which the unevenness in brilliance is suppressed can be formed on a recording medium in which the transfer amount is within the above-described range and the ink absorption amount is relatively small. The transfer amount being greater than or equal to 1 ml/m² at a contact time of 100 ms and being greater than or equal to 2 ml/m² at a contact time of 400 ms represents that the absorption rate is slow but a recording medium has a pigment layer which can absorb ink. In addition, the transfer amount being less than or equal to 15 ml/m² at a contact time of 100 ms and being less than or equal to 20 ml/m² at a contact time of 400 ms represents that the ink absorption amount is relatively small. That is, “the amount of pure water transferred onto a recording medium which is measured with a dynamic scanning absorptometer” being within the above-described range represents that the recording medium has a pigment layer and the permeation amount of ink is small.

The dynamic scanning absorptometer (DSA, Japan TAPPI Journal, Vol. 48, May 1994, pp. 88 to 92, Shigenori Kuga) described herein is a device which can accurately measure the liquid absorption amount within a very short time. The dynamic scanning absorptometer is a device which automatically performs the measurement in the following method: (1) the liquid absorption rate is directly read from the movement of a meniscus in a capillary; (2) the shape of a sample is set to a disk shape and a liquid absorption head thereon is scanned in a spiral shape; and (3) the scanning rate is automatically changed according to a preset pattern and the measurement is performed the number of times required for each sample. The head for supplying liquid into a paper sample is connected to the capillary through a Teflon (trade name) pipe and the position of the meniscus in the capillary is automatically read by an optical sensor. Specifically, the transfer amount of pure water or ink is measured using a dynamic scanning absorptometer (K350 series D-type, manufactured by Kyowa Co., Ltd.). The transfer amount at contact times of 100 ms and 400 ms can be obtained by interpolation from measured values of the transfer amount at contact times neighboring each contact time of 100 ms and 400 ms under conditions of 23° C. and 50% RH.

In the embodiment, the amount of pure water transferred onto the recording medium at a contact time of 100 ms, which is measured with the dynamic scanning absorptometer, is preferably 1 ml/m² to 15 ml/m², more preferably 1 ml/m² to 10 ml/m², and still more preferably 1 ml/m² to 8 ml/m². When the transfer amount of pure water at a contact time of 100 ms is excessively small, beading is likely to occur. In addition, when the transfer amount is much greater than 15 ml/m², the diameter of ink dots after recording may be excessively smaller than a desired diameter.

When ink jet recording is performed, beading described herein is a phenomenon in which, during a period from the application of a previous ink droplet to the application of a subsequent ink droplet onto a recording medium, the previous ink droplet in the liquid state remains on a surface of the recording medium without being absorbed into the recording medium and is mixed with the subsequent ink droplet; and as a result, a part of colorant in the ink aggregates and causes unevenness in density.

In the embodiment, the transfer amount of pure water at a contact time of 400 ms, which is measured with the dynamic scanning absorptometer, is preferably 2 ml/m² to 20 ml/m², more preferably 2 ml/m² to 15 ml/m², and still more preferably 2 ml/m² to 10 ml/m². When the transfer amount of pure water at a contact time of 400 ms is excessively small, a drying property is insufficient and spur marks are easily generated. In addition, when the transfer amount is much greater than 20 ml/m², bleeding is likely to occur and the brilliance of a dried image portion is likely to be low.

The pigment layer includes a pigment and a pigment binder as a major component. The transfer amount can be adjusted to be reduced by increasing the mixing amount of resins, and the transfer amount can be adjusted to increase by increasing the mixing amount of the pigment. Furthermore, the particle size, for example, can be reduced by increasing the specific surface area of pigment particles constituting the pigment layer, and the transfer amount can increase by using a kind of pigment having a large specific surface area.

As the coated paper, for example, lightweight coated paper or fine coated paper is preferably used, and general coated paper which is commercially available can be used. As examples of the coated paper, coated paper for general printing can be used. Specifically, examples of A2 glossy paper include “OK TOPCOAT+” (manufactured by Oji Paper Co., Ltd.), “AURORA COAT” (manufactured by Nippon Paper Group), “PEARL COAT” (manufactured by Mitsubishi Paper Mills, Ltd.), “S-UTRILLO COAT” (manufactured by Daio Paper Corp.), “MU COAT NEOS” (manufactured by Hokuetsu Kishu Paper Co., Ltd.), and “RAICHO COAT” (manufactured by Chuetsu Pulp & Paper Co., Ltd.); examples of A2 matte paper include “NEWAGE” (manufactured by Oji Paper Co., Ltd.), “OK TOPCOAT MAT” (manufactured by Oji Paper Co., Ltd.), “U-LITE” (manufactured by Nippon Paper Group), “NEW V MAT” (manufactured by Mitsubishi Paper Mills, Ltd.), and “RAICHO MAT COAT N” (manufactured by Chuetsu Pulp & Paper Co., Ltd.); examples of A1 gloss art paper include “OK KINFUJI+” (manufactured by Oji Paper Co., Ltd.), “TOKUBISHI ART” (manufactured by Mitsubishi Paper Mills, Ltd.), and “RAICHO SPECIAL ART” (manufactured by Chuetsu Pulp & Paper Co., Ltd.); examples of A1 dull art paper include “SATIN KINFUJI+” (manufactured by Oji Paper Co., Ltd.), “SUPER MAT ART” (manufactured by Mitsubishi Paper Mills, Ltd.), and “RAICHO DULL ART” (manufactured by Chuetsu Pulp & Paper Co., Ltd.); and examples of A0 art paper include “SA KINFUJI+” (manufactured by Oji Paper Co., Ltd.), “HIGH-GRADE ART” (manufactured by Mitsubishi Paper Mills, Ltd.), “RAICHO SUPER ART N” (manufactured by Chuetsu Pulp & Paper Co., Ltd.), “ULTRA SATIN KINFUJI+” (manufactured by Oji Paper Co., Ltd.), and “DIA PREMIER DULL ART” (manufactured by Mitsubishi Paper Mills, Ltd.).

Ink Jet Recording Apparatus

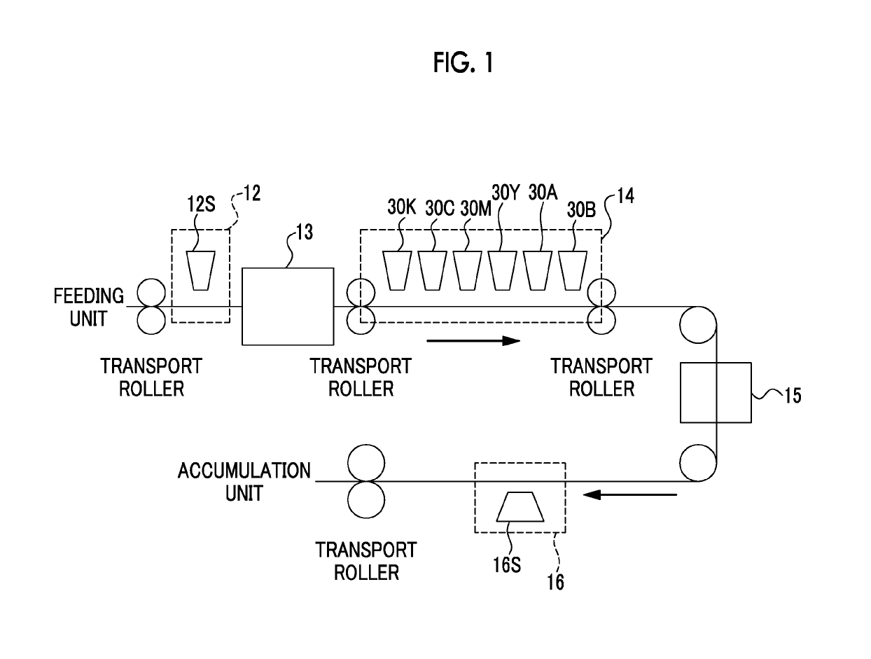

Next, a preferable example of an ink jet recording apparatus, which forms an image with the ink forming method according to the embodiment, will be described in detail with reference to FIG. 1. FIG. 1 is a diagram schematically illustrating a configuration example of the entire ink jet recording apparatus.

As illustrated in FIG. 1, in the ink jet recording apparatus, a treatment solution application unit 12 having a treatment solution discharge head 12S which discharges the treatment solution; a treatment solution drying zone 13 having heating means (not illustrated) for drying the applied treatment solution; an ink discharge unit 14 which discharges various kinds of ink compositions; and an ink drying zone 15 which dries the discharged ink compositions are sequentially arranged toward a transport direction (direction indicated by arrows in the drawing) of a recording medium. An ultraviolet irradiation unit 16 having an ultraviolet ray irradiation lamp 16S is arranged downstream of the ink drying zone 15 in the transport direction of the recording medium.

A recording medium, supplied to the ink jet recording apparatus, is transported from a sheet feeding portion, which feeds a recording medium from a case with recording mediums piled, to the treatment solution application unit 12, the treatment solution drying zone 13, the ink discharge unit 14, the ink drying zone 15, and the ultraviolet irradiation unit 16 in order by transport rollers. Then, the recording medium is collected by a collection portion. As a transporting method other than the method using the transport rollers, a drum transport method using drum members, a belt transport method, or a stage transport method using a stage may be used.

Among the plural transport rollers which are arranged, at least one roller may be a drive roller to which power of a motor (not illustrated) is transmitted. When the drive roller is rotated at a constant rate by the motor, the recording medium is transported in a predetermined direction by a predetermined transport amount.

The treatment solution application unit 12 is provided with the treatment solution discharge head 12S which is connected to a storage tank storing the treatment solution. The treatment solution discharge head 12S discharges the treatment solution from discharge nozzles, which are provided opposite a recording surface of a recording medium, to apply the treatment solution onto the recording medium. The treatment solution application unit 12 is not limited to the method of discharging the treatment solution from a nozzle head, and can adopt a coating method using a coating roller. With this coating method, the treatment solution can be easily applied, by the ink discharge unit 14 which is arranged on the downstream side, onto almost the entire surface of a recording medium including an image region to which droplets of the ink compositions are applied. In order to make the thickness of the treatment solution uniform on the recording medium, various method may be used, for example, an air knife is used, or a gap corresponding a predetermined amount of the treatment solution is provided between the treatment solution and the recording medium and a member having an acute angle is provided in the gap.

The treatment solution drying zone 13 is arranged downstream of the treatment solution application unit 12 in the transport direction of the recording medium. The treatment solution drying zone 13 can be configured by well-known heating means such as a heater, blowing means for blowing air such as a drier, or a combination thereof. Examples of a heating method using the heating means include a method of providing a heating element such as a heater on the opposite surface of a recording medium to a blocking-layer-formed surface (for example, on a lower side of a transport mechanism, on which a recording medium is placed and transported, when the recording medium is automatically transported); a method of blowing warm air or hot air to an blocking-layer-formed surface of a recording medium; and a heating method using an infrared heater. Heating may be performed in a combination of plural methods among the above-described methods.

In addition, the surface temperature of a recording medium varies depending on the kind (for example, material and thickness) of the recording medium and the ambient temperature. Therefore, in order to form a blocking layer while controlling the temperature, it is preferable that a measurement unit which measures the surface temperature of a recording medium; and a control mechanism which feeds surface temperature values of the recording medium, measured by the measurement unit, back to a heat controller be provided. A contact or non-contact thermometer is preferable as the measurement unit which measures the surface temperature of a recording medium.

In addition, a solvent may be removed using a solvent removal roller and the like. As another configuration, a method of removing a surplus solvent from a recording medium with an air knife can be adopted.

The ink discharge unit 14 is arranged downstream of the treatment solution drying zone 13 in the transport direction of the recording medium. In the ink discharge unit 14, recording heads (ink discharge heads) 30K, 30C, 30M, and 30Y, which are respectively connected to ink storage portions storing inks of various colors including black (K), cyan (C), magenta (M), and yellow (Y), are arranged. The respective ink storage portions (not illustrated) stores ink compositions each of which contains a pigment corresponding to each hue, resin particles, a water-soluble organic solvent, and water. When an image is formed, the ink storage portions supply the ink compositions to the ink discharge heads 30K, 30C, 30M, and 30Y as necessary. In addition, as illustrated in FIG. 1, special color ink discharge recording heads 30A and 30B may be further provided on the downstream side of the ink discharge heads 30K, 30C, 30M, and 30Y in the transport direction so as to discharge a special color ink as necessary.

The ink discharge heads 30K, 30C, 30M, and 30Y discharge inks according to an image from discharge nozzles which are provided opposite to a recording surface of a recording medium. As a result, the respective color inks are applied onto the recording surface of the recording medium to form a color image.

All of the treatment solution discharge head 12S and the ink discharge heads 30K, 30C, 30M, 30Y, 30A, and 30B are full-line heads in which plural discharge holes (nozzles) are aligned along a maximum recording width of an image which is formed on the recording medium. The treatment solution discharge head and the ink discharge heads can form an image on a recording medium with higher speed as compared to a serial head in which recording is performed while reciprocating a short shuttle head to perform scanning in a width direction of a recording medium (a direction perpendicular to the transport direction on a transport surface of a recording medium). In the embodiment, either the serial recording method or a relatively high-speed recording method such as a single-pass method in which one line is formed for each scanning, can be adopted. In the image forming method according to the embodiment, a high-quality image having high color reproduction is obtained even when the single-pass method is used.

All of the treatment solution discharge head 12S and the ink discharge heads 30K, 30C, 30M, 30Y, 30A, and 30B have the same structure.

It is preferable that the application amount of the treatment solution and the application amount of the ink compositions be adjusted as necessary. For example, in order to adjust the physical properties such as viscoelasticity of aggregates, obtained by mixing the treatment solution and the ink compositions, the application amount of the treatment solution may be changed according to the recording medium.

The ink drying zone 15 is arranged downstream of the ink discharge unit 14 in the transport direction of the recording medium. The ink drying zone 15 can have the same configuration as that of the treatment solution drying zone 13.

The ultraviolet irradiation unit 16 is arranged downstream of the ink drying zone 15 in the transport direction of the recording medium. A dried image is irradiated with ultraviolet rays, which are emitted from the ultraviolet ray irradiation lamp 16S provided in the ultraviolet irradiation unit 16, so as to cure monomer components in the image for polymerization. The ultraviolet ray irradiation lamp 16S irradiates the entire recording surface with ultraviolet rays by a lamp, which is provided opposite the recording surface of the recording medium, so as to cure the entire image. The ultraviolet ray irradiation unit 16 is not limited to the ultraviolet ray irradiation lamp 16S, and a halogen lamp, a high-pressure mercury lamp, a laser, an LED, an electron-beam irradiation device, or the like can be adopted. The ultraviolet ray irradiation unit 16 may be provided either before or after the ink drying zone 15 or both before and after the ink drying zone 15.

In addition, in the ink jet recording apparatus, heating means for heating a recording medium can be arranged on a transport path from the sheet feeding portion to the collection portion. For example, when the heating means is arranged at a desired position, for example, upstream side of the treatment solution drying zone 13 or between the ink discharge unit 14 and the ink drying zone 15, the recording medium can be heated to a desired temperature. As a result, drying and fixing can be efficiently performed.

### EXAMPLES

Hereinafter, examples of the embodiment will be described in further detail. However, the embodiment is not limited to the following examples within a range not departing from the concepts thereof. “Parts” represents “parts by mass” unless specified otherwise.

### Example 1

### Preparation of Yellow Pigment Dispersion

### Preparation of Polymeric Dispersant Solution 1

6 parts of styrene, 11 parts of stearyl methacrylate, 4 parts of STYRENE MACROMER AS-6 (manufactured by Toagosei Co., Ltd.), 5 parts of BLEMMER PP-500 (manufactured by NOF Corporation), 5 parts of methacrylic acid, 0.05 parts of 2-mercaptoethanol, and 24 parts of methyl ethyl ketone were added to a reaction vessel to prepare a mixed solution. Meanwhile, 14 parts of styrene, 24 parts of stearyl methacrylate, 9 parts of STYRENE MACROMER AS-6 (manufactured by Toagosei Co., Ltd.), 9 parts of BLEMMER PP-500 (manufactured by NOF Corporation), 10 parts of methacrylic acid, 0.13 parts of 2-mercaptoethanol, 56 parts of methyl ethyl ketone, and 1.2 parts of 2,2′-azobis(2,4-dimethylvaleronitrile) were added to a dropping funnel to prepare a mixed solution. Then, the mixed solution in the reaction vessel was heated at 75° C. while stirring the mixed solution in a nitrogen atmosphere, and the mixed solution in the dropoping funnel was gradually added dropwise thereto for 1 hour. After 2 hours from the completion of dropwise addition, a solution, obtained by dissolving 1.2 parts of 2,2′-azobis(2,4-dimethylvaleronitrile) in 12 parts of methyl ethyl ketone, was added dropwise thereto for 3 hours, followed by being left to stand at 75° C. for 2 hours and at 80° C. for 2 hours. As a result, a polymeric dispersant solution 1 was obtained.

A solid content was separated by removing a solvent from a part of the obtained polymeric dispersant solution 1. The obtained solid content was diluted to 0.1% by mass with tetrahydrofuran. Three of TSKgeL Super HZM-H, TSKgeL Super HZ4000, and TSKgeL Super HZ2000 (manufactured by Tosoh Corporation) were connected in series to measure the weight average molecular weight with high-speed gel permeation chromatography (GPC) equipment HLC-8220GPC. As a result of the measurement, the weight average molecular weight was 25,000 in terms of polystyrene.

In addition, the acid value of the polymer was 99 mgKOH/g calculated by a method according to JIS standard (JIS K0070:1992).

### Preparation of Yellow Pigment Dispersion Y1

Next, 5.0 g (in terms of solid content) of the obtained polymer dispersant solution 1, 10.0 g of C.I. Pigment Yellow 74 as a yellow pigment, 40.0 g of methyl ethyl ketone, 8.0 g of 1 mol/L (liter; hereinafter, the same shall be applied) aqueous sodium hydroxide solution, and 82.0 g of ion exchange water were supplied to a vessel with 300 g of 0.1 mm zirconia beads, followed by dispersion with a ready mill disperser (manufactured by Aimex Co., Ltd.) at 1000 rpm for 6 hours. The obtained dispersion was concentrated under reduced pressure until methyl ethyl ketone was sufficiently removed by distillation, and was further concentrated until the concentration of the pigment was 10% by mass. As a result, a yellow pigment dispersion Y1 in which the water-dispersible pigment is dispersed was prepared.

The volume average particle size (secondary particle) of the obtained yellow pigment dispersion Y1 was 77 nm when measured according to a dynamic light scattering method using a Microtrac particle size distribution analyzer (Version 10.1.2-211BH (trade name), manufactured by Nikkiso Co., Ltd.).

### Synthesis of Self-Dispersible Polymer Particles

Into a 2 L three-necked flask equipped with a stirrer, a thermometer, a reflux condenser, and a nitrogen gas introducing tube, 360.0 g of methyl ethyl ketone was put, followed by heating at 75° C. Then, a mixed solution, obtained by mixing 180.0 g of phenoxy ethyl acrylate, 162.0 g of methyl methacrylate, 18.0 g of acrylic acid, 72 g of methyl ethyl ketone, and 1.44 g of “V-601” (manufactured by Wako Pure Chemical Industries Ltd., dimethyl 2,2′-azobis(2-methylpropionate)) with each other, was added dropwise thereto at a constant speed such that the addition was completed after 2 hours, while maintaining the temperature in the flask at 75° C. After the dropwise addition, a mixed solution of 0.72 g of “V-601” and 36.0 g of methyl ethyl ketone were added thereto, followed by stirring at 75° C. for 2 hours. Furthermore, a mixed solution of 0.72 g of “V-601” and 36.0 g of isopropanol were added thereto, followed by stirring at 75° C. for 2 hours. Then, the temperature was raised to 85° C. and stirring was continued for 2 hours. As a result, a resin solution of a phenoxy ethyl acrylate/methyl methacrylate/acrylic acid (=50/45/5 in terms of mass ratio) copolymer was obtained.

The weight average molecular weight of the obtained copolymer was 64,000 when measured in the same manner as that of the polymer dispersant solution 1 (gel permeation chromatography (GPC); in terms of polystyrene), and the acid value thereof was 38.9 mgKOH/g.

Next, 668.3 g of the obtained resin solution was weighed and prepared. 388.3 g of isopropanol and 145.7 ml of 1 mol/L NaOH aqueous solution were added thereto and the temperature in the reaction vessel was raised to 80° C. Next, 720.1 g of distilled water was added dropwise to the heated solution at a rate of 20 ml/min, followed by water dispersion. Then, the resultant was left to stand under atmospheric pressure at temperatures in the reaction vessel of 80° C. for 2 hours, at 85° C. for 2 hours, and at 90° C. for 2 hours. The pressure in the reaction vessel was reduced and 913.7 g in total of isopropanol, methyl ethyl ketone, and distilled water was removed by distillation. As a result, an aqueous dispersion P-1 of 28.0% by mass (in terms of solid concentration) of self-dispersible polymer particles was obtained.

### Synthesis of Polymerizable Compound

### Polymerizable Monomer 1

To a 1 L three-necked flask equipped with a stirrer, 40.0 g (182 mmol) of 4,7,10-trioxa-1,13-tridecanediamine, 37.8 g (450 mmol) of sodium hydrogen carbonate, 100 g of water, and 300 g of tetrahydrofuran were added. Then, 35.2 g (389 mmol) of acrylic acid chloride was added dropwise to the reaction system for 20 minutes in an ice bath. After the dropwise addition, the obtained solution was stirred at room temperature for 5 hours to obtain a reaction mixture. Tetrahydrofuran was removed from the obtained reaction mixture under reduced pressure. Next, the water phase was extracted four times with 200 ml of ethyl acetate. The obtained organic phase was dried with magnesium sulfate, followed by filtration and solvent was removed from the obtained filtrate under reduced pressure. As a result, 35.0 g (107 mmol, yield 59%) of the following desired solid polymerizable monomer 1 was obtained.

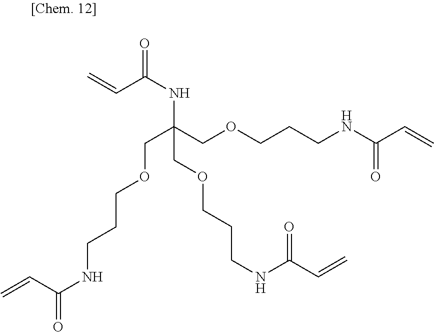 [SMILES: C=CC(=O)NCCCOCC(COCCCNC(=O)C=C)(COCCCNC(=O)C=C)NC(=O)C=C]

Polymerizable Compound 2

The following polymerizable monomer 2 was synthesized according to the synthesis order of the polymerizable monomer 1.

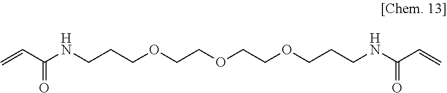 [SMILES: C=CC(=O)NCCCOCCOCCOCCCNC(=O)C=C]

### Preparation of Yellow Ink

(1) Preparation of Yellow Ink 1

The yellow pigment dispersion Y1 was prepared as described above. The aqueous dispersion P-1 of self-dispersible polymer particles, the polymerizable monomer 1, an organic solvent, a surfactant, and ion exchange water were added thereto. As a result, an ink having the following composition was prepared. After the preparation, coarse particles were removed from the obtained ink through a 5 μm filter. As a result, a yellow ink 1 was obtained.

Composition of Yellow Ink 1

| | |
|---|---|
| Yellow pigment dispersion Y1 | 40% by mass (solid |
| | concentration in ink: |
| | 4% by mass) |
| Aqueous dispersion P-1 of self-dispersible | 14.3% by mass (solid |
| polymer particles | concentration in ink: |
| | 4% by mass) |
| Polymerizable monomer 1 | 10% by mass |
| Dimethylacrylamide | 5.5% by mass |
| OLFIN E1010 (manufactured by Nissin Chemical | 1% by mass |
| Industry Co., Ltd.) | |
| Polymerization initiator (IRGACURE 2959, | 3% by mass |
| manufactured by BASF Japan Ltd., | |
| 1-[4-(2-hydroxyethoxy)-phenyl]-2- | |
| hydroxy-2-methyl-1-propane-1-one) | |
| Ion exchange water | balance (with respect |
| | to the total amount |
| | of 100% by mass) |

(2) Preparation of Yellow Inks 2 to 5

Yellow inks 2 to 5 were prepared in the same preparation method as that of the yellow ink 1, except that the content of the polymerizable monomer 1 was changed from 10% by mass to amounts shown in Table 1 below.

(3) Preparation of Yellow Ink 6

A yellow ink 6 was prepared in the same preparation method as that of the yellow ink 1, except that the polymerizable monomer 1 was changed to the same amount of polymerizable monomer 2.

Preparation of Cyan Ink

A cyan ink was prepared in the same preparation method as that of the yellow ink 1, except that C.I Pigment Blue 15 was used instead of C.I Pigment Yellow 74.

Preparation of Magenta Ink

A magenta ink was prepared in the same preparation method as that of the yellow ink 1, except that C.I Pigment Red 122 was used instead of C.I Pigment Yellow 74.

Preparation of Treatment Solution

The following composition of components were mixed to prepare a treatment solution. In the treatment solution, the viscosity, the surface tension, and the pH (25° C.) were set to 2.5 mPa·s, 40 mN/m, and 1.0, respectively. The pH was measured with a pH meter WM-50EG (manufactured by DKK-Toa Corporation) while maintaining the temperature at 25° C.

Composition of Treatment Solution

| | |
|---|---|
| Malonic acid (manufactured by Wako Pure Chemical | 25% by mass |
| Industries Ltd.) | |
| Diethylene glycol monomethyl ether (manufactured | 20% by mass |
| by Wako Pure Chemical Industries Ltd.) | |
| EMULGEN P109 (manufactured by Kao Corporation, | 1% by mass |
| nonionic surfactant) | |
| Ion exchange water | 54% by mass |

Image Formation and Evaluation

Using the yellow inks 1 to 6, the cyan ink, the magenta ink, and the treatment solution which were obtained above, images were formed with the following method under conditions shown in Tables 1 to 3. The formed images were evaluated as follows.

(1) Image Formation

First, as illustrated in FIG. 1, an ink jet recording apparatus was prepared in which the treatment solution application unit 12 having the treatment solution discharge head 12S which discharges the treatment solution; the treatment solution drying zone 13 which dries the applied treatment solution; the ink discharge unit 14 which discharges various kinds of ink compositions; the ink drying zone 15 which dries the discharged ink compositions; and the UV (ultraviolet) irradiation unit 16 having the UV irradiation lamp 16 which can emit UV rays were sequentially arranged in the transport direction (direction indicated by arrows in the drawing) of a recording medium.

In the ink jet recording apparatus, the treatment solution drying zone 13 is provided with a blower (not illustrated) for blowing warm air on a recording surface side of a recording medium to be dried; and an infrared heater on a non-recording surface side of the recording medium, so as to evaporate (dry) 70% or higher of water in the treatment solution while controlling the temperature and air volume until 900 msec is elapsed after the treatment solution application unit starts the application of the treatment solution. In addition, the ink discharge unit 14 having the cyan ink discharge head 30C, the magenta ink discharge head 30M, and the yellow ink discharge head 30Y are sequentially arranged and each of the heads is full-line head (1200 dpi/10 inch width, drive frequency: 25 kHz, transport rate of recording medium: 530 mm/sec), and the ink discharge unit 14 can discharge the respective color inks to form an image with a single-pass method.

In the ink jet recording apparatus configured as illustrated in FIG. 1, storage tanks (not illustrated), which are respectively connected to the treatment solution discharge head 12S, the yellow ink discharge head 30Y, the cyan ink discharge head 30C, and the magenta ink discharge head 30M, were filled with the obtained treatment solution, yellow ink, cyan ink, and magenta ink. Then, a line image and a solid image were formed on a recording medium so as to obtain a maximum density under conditions shown in Tables 1 to 3 below of the amounts of droplets of ink compositions, the application density, the diameter (dot diameter) of applied ink droplets, and the resolution. At this time, the line image was formed by discharging a 1 dot-width line, a 2 dot-width line, and a 4 dot-width line at 1200 dpi, 1440 dpi, 1600 dpi and 900 dpi, with a single-pass method. The solid image was formed by discharging the ink onto the entire surface of a sample which was obtained by cutting the recording medium into AS size. The amount of the treatment solution applied onto a recording medium was 5 ml/m². The treatment solution was applied at a resolution of 1200 dpix600 dpi and an amount of droplets of 3.5 pl. As the recording medium, U-LITE (manufactured by Nippon Paper Group Inc., basis weight: 84.9 g/m², transfer amount of pure water measured with dynamic scanning absorptometer: 3 ml/m² at contact time of 100 ms and 5 ml/m² at contact time of 400 ms) was used.

In order to form an image, first, the treatment solution was discharged from the treatment solution discharge head 12S onto one surface of a recording medium with a single-pass method. Then, the recording medium was dried in the treatment solution drying zone 13 so as to pass through the treatment solution drying zone within 900 msec after starting the discharge of the treatment solution. In the treatment solution drying zone 13, the applied treatment solution was blown with warm air at 120° C. by a blower from the treatment solution-applied surface while being heated by an infrared heater from the rear side (back surface) of the applied surface such that the surface temperature is 40° C. to 45° C. The air volume was changed and controlled so as to obtain a predetermined drying amount. Next, the cyan ink was discharged from the cyan ink discharge head 30C to form a cyan solid image; and the yellow ink was discharged from the yellow ink discharge head 30Y thereonto with a single-pass method to form yellow line and solid images in an overlapping manner. At this time, as the yellow ink, the prepared yellow inks 1 to 6 were left to stand at 5° C. for 14 days, respectively and sequentially used. The recording medium, on which the respective images were formed, was dried in the ink drying zone 15 in the same manner as above in which the ink applied surface was blown with warm air by a blower at 120° C. and 5 msec for 15 seconds while the rear side (back surface) of the ink applied surface was heated by an infrared heater. After being dried, the images were cured in the UV irradiation unit 16 by irradiating the images with UV rays (using a metal halide lamp (manufactured by Eye Graphic Co., Ltd) at a maximum irradiation wavelength of 365 nm) such that the integrated irradiation amount of UV rays was 3 J/cm². Various patterns of solid images (having different ratios of diameters φ² and φ³) were prepared for evaluating the color reproduction, the graininess, and the streak defects.

(2) Evaluation

The formed images were evaluated as follows. The evaluation results are shown in Tables 1 to 3.

1. Color Reproduction

A Lab value (value of CIE 1976 L*a*b* color space) was measured with a spectrophotometer (SPECTROEYE). The color gamut was obtained by calculating the numerical value of the Lab value, and was evaluated based on the following evaluation criteria. At this time, in CIELAB, the color gamut, which is completely reproduced by all the possible secondary colors formed of primary colors, is represented by 100%.

Evaluation Criteria

A: 98% or higher

B: 95% or higher and lower than 98%

C: 92% or higher and lower than 95% D: 90% or higher and lower than 92% E: lower than 90%

2. Graininess

When the density in the solid images was measured and the variation in density was represented over a period, the granularity (L*^{noise}) was obtained by calculating a root-mean-square (RMS). The obtained L*^{noise} was evaluated based on the following evaluation criteria.

Evaluation Criteria

A: L*^{noise} is smaller than or equal to 2

B: L*^{noise} is smaller than or equal to 3

C: L*^{noise} is smaller than or equal to 4

D: L*^{noise} is smaller than or equal to 5

E: L*^{noise} is greater than or equal to 6

3. Streak Defects

Whether there were streaks in the solid image was visually inspected, and the evaluation was performed based on the following evaluation criteria.

Evaluation Criteria

A: No streaks were observed

B: Almost no streaks were observed

C: Clear streaks were not observed

D: A small amount of streaks were observed

E: Clear streaks were observed

TABLE 1

| | | Polymerizable | | | Amount of Droplets (pl) | | Application Density (%) | | |
|---|---|---|---|---|---|---|---|---|---|
| | | Compound | | | Droplets having | Droplets having | Total | Droplets having | Droplets having |
| | | | Content | Kind of | Minimum volume | Second Minimum | Applica- | Minimum volume | Second Minimum |
| | | | (% by | Treatment | of Ink | volume of Ink | tion | of Ink | volume of Ink |
| No. | | Kind | mass) | Solution | Composition | Composition | Density | Composition | Composition |
| 1 | Ink | Mono- | 10 | Treatment | 1.65 | 4.8 | 100 | 100 | — |
| 2 | 1 | mer 1 | | Solution | 2.00 | 4.8 | 100 | 100 | — |
| 3 | | | | 1 | 2.40 | 4.8 | 100 | 100 | — |
| 4 | | | | | 2.85 | 4.8 | 100 | 100 | — |
| 5 | | | | | 3.10 | 4.8 | 100 | 100 | — |
| 6 | Ink | Mono- | 5 | Treatment | 1.59 | 4.8 | 100 | 100 | — |
| 7 | 2 | mer 1 | | Solution | 1.93 | 4.8 | 100 | 100 | — |
| 8 | | | | 1 | 2.32 | 4.8 | 100 | 100 | — |
| 9 | | | | | 2.75 | 4.8 | 100 | 100 | — |
| 10 | | | | | 2.98 | 4.8 | 100 | 100 | — |
| 11 | Ink | Mono- | 4 | Treatment | 1.55 | 4.8 | 100 | 100 | — |
| 12 | 3 | mer 1 | | Solution | 1.88 | 4.8 | 100 | 100 | — |
| 13 | | | | 1 | 2.25 | 4.8 | 100 | 100 | — |
| 14 | | | | | 2.67 | 4.8 | 100 | 100 | — |
| 15 | | | | | 3.15 | 4.8 | 100 | 100 | — |
| 16 | Ink | Mono- | 15 | Treatment | 1.71 | 4.8 | 100 | 100 | — |
| 17 | 4 | mer 1 | | Solution | 2.08 | 4.8 | 100 | 100 | — |
| 18 | | | | 1 | 2.50 | 4.8 | 100 | 100 | — |
| 19 | | | | | 2.96 | 4.8 | 100 | 100 | — |
| 20 | | | | | 3.22 | 4.8 | 100 | 100 | — |
| 21 | Ink | Mono- | 16 | Treatment | 1.77 | 4.8 | 100 | 100 | — |
| 22 | 5 | mer 1 | | Solution | 2.14 | 4.8 | 100 | 100 | — |
| 23 | | | | 1 | 2.57 | 4.8 | 100 | 100 | — |
| 24 | | | | | 3.05 | 4.8 | 100 | 100 | — |
| 25 | | | | | 3.59 | 4.8 | 100 | 100 | — |

| | | | Diameters (μm) of Droplets of | | | | | | |
|---|---|---|---|---|---|---|---|---|---|
| | | | Ink Compositions Applied | | | Evaluation | | | |
| | | | Average | | | Color | | | |
| | | Resolution | Diameter | Diameter | Diameter | Reproduction | Grain- | Streak | |
| No. | | (dpi) | φ¹ | φ² | φ³ | ΔE | iness | Defects | Note |
| 1 | Ink | 1200 | 30 | 30 | — | D | B | E | Comparative |
| | 1 | | | | | | | | Example |
| 2 | | | 32 | 32 | — | B | B | C | Example |
| 3 | | | 34 | 34 | — | A | B | C | Example |
| 4 | | | 36 | 36 | — | A | B | C | Example |
| 5 | | | 37 | 37 | — | D | B | C | Comparative |
| | | | | | | | | | Example |
| 6 | Ink | | 30 | 30 | — | E | B | C | Comparative |
| | 2 | | | | | | | | Example |
| 7 | | | 32 | 32 | — | B | B | C | Example |
| 8 | | | 34 | 34 | — | A | B | B | Example |
| 9 | | | 36 | 36 | — | B | B | C | Example |
| 10 | | | 37 | 37 | — | E | B | C | Comparative |
| | | | | | | | | | Example |
| 11 | Ink | | 30 | 30 | — | E | B | C | Comparative |
| | 3 | | | | | | | | Example |
| 12 | | | 32 | 32 | — | D | B | C | Comparative |
| | | | | | | | | | Example |
| 13 | | | 34 | 34 | — | D | B | C | Comparative |
| | | | | | | | | | Example |
| 14 | | | 36 | 36 | — | D | B | C | Comparative |
| | | | | | | | | | Example |
| 15 | | | 38 | 38 | — | E | B | C | Comparative |
| | | | | | | | | | Example |
| 16 | Ink | | 30 | 30 | — | C | B | E | Comparative |
| | 4 | | | | | | | | Example |
| 17 | | | 32 | 32 | — | A | B | C | Example |
| 18 | | | 34 | 34 | — | A | B | C | Example |
| 19 | | | 36 | 36 | — | A | B | C | Example |
| 20 | | | 37 | 37 | — | C | B | C | Comparative |
| | | | | | | | | | Example |
| 21 | Ink | | 30 | 30 | — | E | B | E | Comparative |
| | 5 | | | | | | | | Example |
| 22 | | | 32 | 32 | — | D | B | E | Comparative |
| | | | | | | | | | Example |
| 23 | | | 34 | 34 | — | D | B | E | Comparative |
| | | | | | | | | | Example |
| 24 | | | 36 | 36 | — | D | B | E | Comparative |
| | | | | | | | | | Example |
| 25 | | | 38 | 38 | — | E | B | E | Comparative |
| | | | | | | | | | Example |

“Total Application Density” is the total value of “Ink Droplets having Minimum volume” and “Ink Droplets having Second Minimum volume”.

TABLE 2

| | | Polymerizable | | | Amount of Droplets (pl) | | Application Density (%) | | |
|---|---|---|---|---|---|---|---|---|---|
| | | Compound | | | Droplets having | Droplets having | Total | Droplets having | Droplets having |
| | | | Content | Kind of | Minimum volume | Second Minimum | Applica- | Minimum volume | Second Minimum |
| | | | (% by | Treatment | of Ink | volume of Ink | tion | of Ink | volume of Ink |
| No. | | Kind | mass) | Solution | Composition | Composition | Density | Composition | Composition |
| | Ink | Mono- | 10 | Treatment | 2.4 | 4.8 | 100 | 100 | |
| 26 | 1 | mer 1 | | Solution | 2.4 | 4.8 | 90 | 85 | 5 |
| 27 | | | | 1 | 2.4 | 4.8 | 95 | 80 | 15 |
| 28 | | | | | 2.4 | 4.8 | 93 | 70 | 23 |
| 29 | | | | | 2.4 | 4.8 | 90 | 60 | 30 |
| 30 | | | | | 2.4 | 4.8 | 88 | 50 | 38 |
| 31 | | | | | 2.4 | 4.8 | 87 | 45 | 42 |
| | Ink | Mono- | 10 | Treatment | 2.4 | 5.6 | 100 | 100 | |
| 32 | 1 | mer 1 | | Solution | 2.4 | 5.6 | 95 | 80 | 15 |
| 33 | | | | 1 | 2.4 | 5.6 | 92 | 70 | 22 |
| 34 | | | | | 2.4 | 5.6 | 89 | 60 | 29 |
| 35 | | | | | 2.4 | 5.6 | 86 | 50 | 36 |
| 36 | | | | | 2.4 | 5.6 | 85 | 45 | 40 |
| | Ink | Mono- | 10 | Treatment | 2.4 | 6.5 | 100 | 100 | |
| 37 | 1 | mer 1 | | Solution | 2.4 | 6.5 | 94 | 80 | 14 |
| 38 | | | | 1 | 2.4 | 6.5 | 90 | 70 | 20 |
| 39 | | | | | 2.4 | 6.5 | 87 | 60 | 27 |
| 40 | | | | | 2.4 | 6.5 | 84 | 50 | 34 |
| 41 | | | | | 2.4 | 6.5 | 82 | 45 | 37 |
| | Ink | Mono- | 10 | Treatment | 2.4 | 7.0 | 100 | 100 | |
| 42 | 1 | mer 1 | | Solution | 2.4 | 7.0 | 93 | 80 | 13 |
| 43 | | | | 1 | 2.4 | 7.0 | 91 | 70 | 21 |
| 44 | | | | | 2.4 | 7.0 | 87 | 60 | 27 |
| 45 | | | | | 2.4 | 7.0 | 84 | 50 | 34 |
| 46 | | | | | 2.4 | 7.0 | 95 | 45 | 50 |
| | Ink | Mono- | 10 | Treatment | 2.4 | 4.2 | 100 | 100 | |
| 47 | 1 | mer 1 | | Solution | 2.4 | 4.2 | 96 | 80 | 16 |
| 48 | | | | 1 | 2.4 | 4.2 | 93 | 70 | 23 |
| 49 | | | | | 2.4 | 4.2 | 91 | 60 | 31 |
| 50 | | | | | 2.4 | 4.2 | 89 | 50 | 39 |
| 51 | | | | | 2.4 | 4.2 | 88 | 45 | 43 |
| 52 | Ink | Mono- | 10 | Treatment | 1.9 | | 100 | 100 | |
| | 1 | mer 1 | | Solution | | | | | |
| | | | | 1 | | | | | |
| 53 | Ink | Mono- | 10 | Treatment | 2.95 | | 100 | 100 | |
| | 1 | mer 1 | | Solution | | | | | |
| | | | | 1 | | | | | |

| | | | Diameters (μm) of Droplets | | | | | | |
|---|---|---|---|---|---|---|---|---|---|
| | | | of Ink Compositions Applied | | | Evaluation | | | |
| | | | Average | | | Color | | | |
| | | Resolution | Diameter | Diameter | Diameter | Reproduction | Grain- | Streak | |
| No. | | (dpi) | φ¹ | φ² | φ³ | ΔE | iness | Defects | Note |
| | Ink | 1200 | 34 | 34 | | A | B | C | Example |
| 26 | 1 | | 33 | 34 | 45 | B | B | D | Comparative |
| | | | | | | | | | Example |
| 27 | | | 34 | 34 | 45 | A | B | C | Example |
| 28 | | | 34 | 34 | 45 | B | B | B | Example |
| 29 | | | 34 | 34 | 45 | B | B | B | Example |
| 30 | | | 34 | 34 | 45 | B | B | C | Example |
| 31 | | | 34 | 34 | 45 | E | C | C | Comparative |
| | | | | | | | | | Example |
| | Ink | | 34 | 34 | | A | B | C | Example |
| 32 | 1 | | 34 | 34 | 48 | A | B | B | Example |
| 33 | | | 34 | 34 | 48 | A | B | B | Example |
| 34 | | | 34 | 34 | 48 | A | C | B | Example |
| 35 | | | 34 | 34 | 48 | B | C | B | Example |
| 36 | | | 34 | 34 | 48 | E | C | B | Comparative |
| | | | | | | | | | Example |
| | Ink | | 34 | 34 | | A | B | C | Example |
| 37 | 1 | | 34 | 34 | 50 | B | C | A | Example |
| 38 | | | 34 | 34 | 50 | B | C | A | Example |
| 39 | | | 34 | 34 | 50 | C | C | A | Example |
| 40 | | | 34 | 34 | 50 | C | C | A | Example |
| 41 | | | 34 | 34 | 50 | E | C | C | Comparative |
| | | | | | | | | | Example |
| | Ink | | 34 | 34 | | A | B | C | Example |
| 42 | 1 | | 34 | 34 | 52 | B | D | A | Comparative |
| | | | | | | | | | Example |
| 43 | | | 35 | 34 | 52 | B | D | A | Comparative |
| | | | | | | | | | Example |
| 44 | | | 34 | 34 | 52 | C | D | A | Comparative |
| | | | | | | | | | Example |
| 45 | | | 34 | 34 | 52 | C | D | A | Comparative |
| | | | | | | | | | Example |
| 46 | | | 41 | 34 | 52 | E | E | C | Comparative |
| | | | | | | | | | Example |
| | Ink | | 34 | 34 | | A | B | C | Example |
| 47 | 1 | | 34 | 34 | 43 | A | B | D | Comparative |
| | | | | | | | | | Example |
| 48 | | | 34 | 34 | 43 | B | B | D | Comparative |
| | | | | | | | | | Example |
| 49 | | | 34 | 34 | 43 | C | B | D | Comparative |
| | | | | | | | | | Example |
| 50 | | | 34 | 34 | 43 | C | B | D | Comparative |
| | | | | | | | | | Example |
| 51 | | | 34 | 34 | 43 | D | C | D | Comparative |
| | | | | | | | | | Example |
| 52 | Ink | | 31 | 31 | | D | B | D | Comparative |
| | 1 | | | | | | | | Example |
| 53 | Ink | | 37 | 37 | | C | B | C | Comparative |
| | 1 | | | | | | | | Example |

TABLE 3

| | | Polymerizable | | | Amount of Droplets (pl) | | Application Density (%) | | |
|---|---|---|---|---|---|---|---|---|---|
| | | Compound | | | Droplets having | Droplets having | Total | Droplets having | Droplets having |
| | | | Content | Kind of | Minimum volume | Second Minimum | Applica- | Minimum volume | Second Minimum |
| | | | (% by | Treatment | of Ink | volume of Ink | tion | of Ink | volume of Ink |
| No. | | Kind | mass) | Solution | Composition | Composition | Density | Composition | Composition |
| 54 | Ink | Mono- | 10 | Treatment | 2.4 | 4.8 | 100 | 100 | — |
| | 6 | mer 2 | | Solution | | | | | |
| | | | | 1 | | | | | |
| 55 | Ink | Mono- | 10 | Treatment | 2.4 | 4.8 | 100 | 100 | — |
| | 1 | mer 1 | | Solution | | | | | |
| | | | | 2 | | | | | |
| 56 | Ink | Mono- | 10 | Treatment | 2.4 | 4.8 | 100 | 100 | — |
| | 1 | mer 1 | | Solution | | | | | |
| | | | | 3 | | | | | |
| 57 | Ink | Mono- | 10 | Treatment | 1.1 | 4.8 | 100 | 100 | — |
| 58 | 1 | mer 1 | | Solution | 1.2 | 4.8 | 100 | 100 | — |
| 59 | | | | 1 | 1.3 | 4.8 | 100 | 100 | — |
| 60 | | | | | 1.7 | 4.8 | 100 | 100 | — |
| 61 | | | | | 1.8 | 4.8 | 100 | 100 | — |
| 62 | Ink | Mono- | 10 | Treatment | 0.75 | 4.8 | 100 | 100 | — |
| 63 | 1 | mer 1 | | Solution | 0.85 | 4.8 | 100 | 100 | — |
| 64 | | | | 1 | 0.95 | 4.8 | 100 | 100 | — |
| 65 | | | | | 1.15 | 4.8 | 100 | 100 | — |
| 66 | | | | | 1.25 | 4.8 | 100 | 100 | — |
| 67 | Ink | Mono- | 10 | Treatment | 4.2 | 4.8 | 100 | 100 | — |
| 68 | 1 | mer 1 | | Solution | 4.7 | 4.8 | 100 | 100 | — |
| 69 | | | | 1 | 5.4 | 4.8 | 100 | 100 | — |
| 70 | | | | | 6.2 | 4.8 | 100 | 100 | — |
| 71 | | | | | 7 | 4.8 | 100 | 100 | — |

| | | | Diameters (μm) of Droplets of | | | | | | |
|---|---|---|---|---|---|---|---|---|---|
| | | | Ink Compositions Applied | | | Evaluation | | | |
| | | | Average | | | Color | | | |
| | | Resolution | Diameter | Diameter | Diameter | Reproduction | Grain- | Streak | |
| No. | | (dpi) | φ¹ | φ² | φ³ | ΔE | iness | Defects | Note |
| 54 | Ink | 1200 | 34 | 34 | — | A | B | C | Example |
| | 6 | | | | | | | | |
| 55 | Ink | | 34 | 34 | — | A | B | C | Example |
| | 1 | | | | | | | | |
| 56 | Ink | | 34 | 34 | — | A | B | C | Example |
| | 1 | | | | | | | | |
| 57 | Ink | 1440 | 26 | 26 | — | E | B | E | Comparative |
| | 1 | | | | | | | | Example |
| 58 | | | 27 | 27 | — | B | B | C | Example |
| 59 | | | 28 | 28 | — | A | B | C | Example |
| 60 | | | 30 | 30 | — | B | B | C | Example |
| 61 | | | 31 | 31 | — | E | B | C | Comparative |
| | | | | | | | | | Example |
| 62 | Ink | 1600 | 23 | 23 | — | E | B | E | Comparative |
| | 1 | | | | | | | | Example |
| 63 | | | 24 | 24 | — | B | B | C | Example |
| 64 | | | 25 | 25 | — | B | B | C | Example |
| 65 | | | 27 | 27 | — | B | B | C | Example |
| 66 | | | 28 | 28 | — | E | B | C | Comparative |
| | | | | | | | | | Example |
| 67 | Ink | 900 | 41 | 41 | — | E | C | D | Comparative |
| | 1 | | | | | | | | Example |
| 68 | | | 43 | 43 | — | C | C | C | Example |
| 69 | | | 45 | 45 | — | C | C | C | Example |
| 70 | | | 47 | 47 | — | C | C | C | Example |
| 71 | | | 49 | 49 | — | D | E | C | Comparative |
| | | | | | | | | | Example |

In aggregation systems having the ink compositions shown in Tables 1 to 3 above, it can be seen that, when droplets of ink compositions having predetermined droplet sizes are applied to form an image such that the average diameter φ¹ of droplets of the ink compositions, the diameter φ² of droplets having the minimum volume of ink composition, the diameter φ³ of droplets having the second minimum volume of ink composition, and the application density fall within predetermined ranges, the color reproduction of the formed image is improved and streak defects in the image are effectively suppressed.

In addition, as shown in No. 26 to 51, even when the diameter φ³ is gradually increased, the change of the average diameter φ¹ is small and is suppressed in the vicinity of 34 μm. When the relational expressions (2) and (3) are satisfied, an image having superior color reproduction and a small amount of streak defects is obtained.

This application claims priority under 35 U.S.C. §119 of Japanese Patent application JP 2012-045814, filed on Mar. 1, 2012 and Japanese Patent application JP 2012-273994, filed on Dec. 14, 2012, the entire contents of which are hereby incorporated by reference.

What is claimed is:

1. An image forming method comprising:
applying two or more kinds of ink compositions having different hues onto a recording medium to form a multi-color image, each ink composition containing at least a pigment, water, and 5% by mass to 15% by mass of polyvalent (meth)acrylamide represented by the following formula (1) with respect to the total amount of the ink composition as a polymerizable compound; and
applying a treatment solution, which contains an aggregation component capable of aggregating components in each of the ink compositions, onto the recording medium,
wherein an average diameter φ¹ (μm) of droplets of the ink compositions on the recording medium satisfies the following relational expression (1), and
an application density of droplets having a minimum volume of ink composition on the recording medium is higher than or equal to 80%.
[Expression 1]
(2.54×10000/R)×1.5≦φ¹≦(2.54×10000/R)×1.7 Relational Expression (1)
In the relational expression (1), R represents a resolution (dot per inch) of an image. 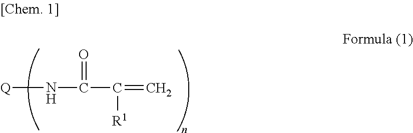
In the formula (1), Q represents an n-valent linking group; R¹ represents a hydrogen atom or a methyl group; and n represents an integer of 2 or more.

2. An image forming method comprising:
applying two or more kinds of ink compositions having different hues onto a recording medium with plural droplets having different volumes of the ink compositions to form a multi-color image, each ink composition containing at least a pigment, water, and 5% by mass to 15% by mass of polyvalent (meth)acrylamide represented by the following formula (1) with respect to the total amount of the ink composition as a polymerizable compound; and
applying a treatment solution, which contains an aggregation component capable of aggregating components in each of the ink compositions, onto the recording medium,
wherein, among the plural droplets of the ink compositions having different volumes on the recording medium, a diameter φ² (μm) of droplets having a minimum volume of ink composition satisfies the following relational expression (2) and a diameter φ³ (μm) of droplets having a second minimum volume of ink composition satisfies the following relational expression (3), and
at least when an image is formed with a maximum density, an application density of droplets having the minimum volume of ink composition on the recording medium is higher than or equal to 50%, an application density of droplets having the second minimum volume of ink composition on the recording medium is higher than or equal to 10%, and a total application density of droplets of all the ink compositions on the recording medium is higher than or equal to 80%.
[Expression 2]
(2.54×10000/R)×1.5≦φ²≦(2.54×10000/R)×1.7 Relational Expression (2)
(2.54×10000/R)×2.1≦φ³≦(2.54×10000/R)×2.4 Relational Expression (3)
In the relational expressions (2) and (3), R represents a resolution (dot per inch) of an image. 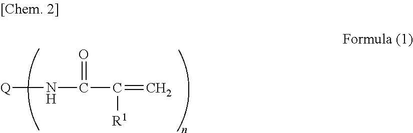
(In the formula (1), Q represents an n-valent linking group; R¹ represents a hydrogen atom or a methyl group; and n represents an integer of 2 or more.)

3. The image forming method according to claim 1,
wherein the resolution R is greater than or equal to 1200 dpi (dot per inch).

4. The image forming method according to claim 2,
wherein the resolution R is greater than or equal to 1200 dpi (dot per inch).

5. The image forming method according to claim 1,
wherein the polyvalent (meth)acrylamide is a compound represented by the following formula (2). 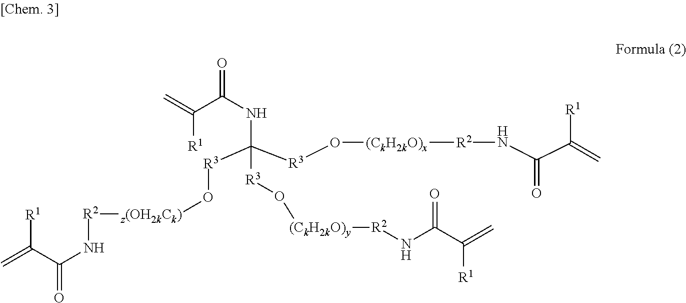
In the formula (2), R¹ represents a hydrogen atom or a methyl group; R² represents a linear or branched alkylene group having 2 to 4 carbon atoms in which an oxygen atom and a nitrogen atom, bonded to both terminals of R², are not bonded to the same carbon atom of R²; R³ represents a divalent linking group; k represents 2 or 3; and x, y, and z each independently represent an integer of 0 to 6 in which a value of x+y+z satisfies an integer of 0 to 18.

6. The image forming method according to claim 2,
wherein the polyvalent (meth)acrylamide is a compound represented by the following formula (2). 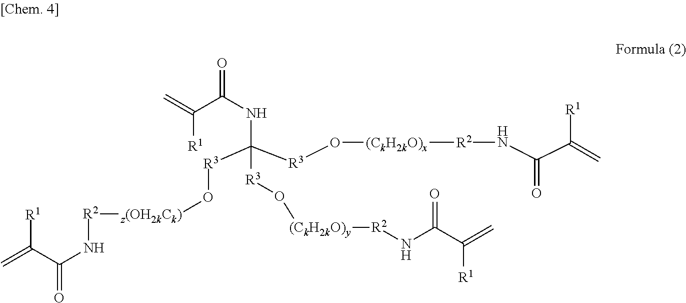
In the formula (2), R¹ represents a hydrogen atom or a methyl group; R² represents a linear or branched alkylene group having 2 to 4 carbon atoms in which an oxygen atom and a nitrogen atom, bonded to both terminals of R², are not bonded to the same carbon atom of R²; R³ represents a divalent linking group; k represents 2 or 3; and x, y, and z each independently represent an integer of 0 to 6 in which a value of x+y+z satisfies an integer of 0 to 18.

7. The image forming method according to claim 1,
wherein the recording medium is a coated paper having a pigment layer on at least one surface of a support, which includes cellulose pulp as a major component.

8. The image forming method according to claim 2,
wherein the recording medium is a coated paper having a pigment layer on at least one surface of a support, which includes cellulose pulp as a major component.

9. The image forming method according to claim 7,
wherein the coated paper is a light-weight coated paper or a fine coated paper.

10. The image forming method according to claim 8,
wherein the coated paper is a light-weight coated paper or a fine coated paper.

11. The image forming method according to claim 1,
wherein the pigment is a water-dispersible pigment in which at least a part of surfaces of pigment particles are coated with a polymeric dispersant.

12. The image forming method according to claim 2,
wherein the pigment is a water-dispersible pigment in which at least a part of surfaces of pigment particles are coated with a polymeric dispersant.

13. The image forming method according to claim 1,
wherein the pigment is a water-dispersible pigment in which at least a part of surfaces of pigment particles are coated with a polymeric dispersant having a carboxyl group.

14. The image forming method according to claim 2,
wherein the pigment is a water-dispersible pigment in which at least a part of surfaces of pigment particles are coated with a polymeric dispersant having a carboxyl group.

15. The image forming method according to claim 1,
wherein the recording medium is a coated paper that has a pigment layer on at least one surface of a support, which includes cellulose pulp as a major component, and that has a transfer amount of pure water of 1 ml/m² to 15 ml/m² at a contact time of 100 ms and a transfer amount of pure water 2 ml/m² to 20 ml/m² at a contact time of 400 ms when measured with a dynamic scanning absorptometer.

16. The image forming method according to claim 2,
wherein the recording medium is a coated paper that has a pigment layer on at least one surface of a support, which includes cellulose pulp as a major component, and that has a transfer amount of pure water of 1 ml/m² to 15 ml/m² at a contact time of 100 ms and a transfer amount of pure water 2 ml/m² to 20 ml/m² at a contact time of 400 ms when measured with a dynamic scanning absorptometer.

17. The image forming method according to claim 1,
wherein at least one of the ink compositions and the treatment solution further contains a polymerization initiator.

18. The image forming method according to claim 2,
wherein at least one of the ink compositions and the treatment solution further contains a polymerization initiator.

19. The image forming method according to claim 3,
wherein the polyvalent (meth)acrylamide is a compound represented by the following formula (2),
the pigment is a water-dispersible pigment in which at least a part of surfaces of pigment particles are coated with a polymeric dispersant having a carboxyl group,
the recording medium has a pigment layer on at least one surface of a support, which includes cellulose pulp as a major component, and has a transfer amount of pure water of 1 ml/m² to 15 ml/m² at a contact time of 100 ms and a transfer amount of pure water 2 ml/m² to 20 ml/m² at a contact time of 400 ms when measured with a dynamic scanning absorptometer, and
at least one of the ink compositions and the treatment solution further contains a polymerization initiator. 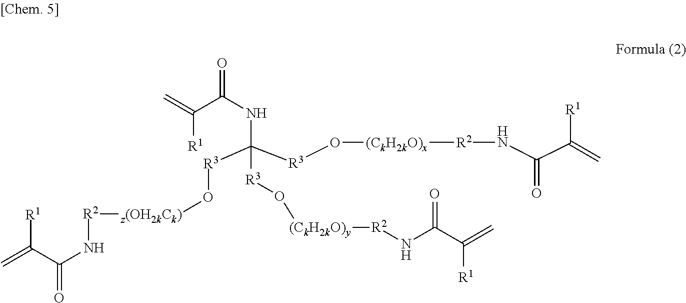
In the formula (2), R¹ represents a hydrogen atom or a methyl group; R² represents a linear or branched alkylene group having 2 to 4 carbon atoms in which an oxygen atom and a nitrogen atom, bonded to both terminals of R², are not bonded to the same carbon atom of R²; R³ represents a divalent linking group; k represents 2 or 3; and x, y, and z each independently represent an integer of 0 to 6 in which a value of x+y+z satisfies an integer of 0 to 18.

20. The image forming method according to claim 4,
wherein the polyvalent (meth)acrylamide is a compound represented by the following formula (2),
the pigment is a water-dispersible pigment in which at least a part of surfaces of pigment particles are coated with a polymeric dispersant having a carboxyl group,
the recording medium has a pigment layer on at least one surface of a support, which includes cellulose pulp as a major component, and has a transfer amount of pure water of 1 ml/m² to 15 ml/m² at a contact time of 100 ms and a transfer amount of pure water 2 ml/m² to 20 ml/m² at a contact time of 400 ms when measured with a dynamic scanning absorptometer, and
at least one of the ink compositions and the treatment solution further contains a polymerization initiator. 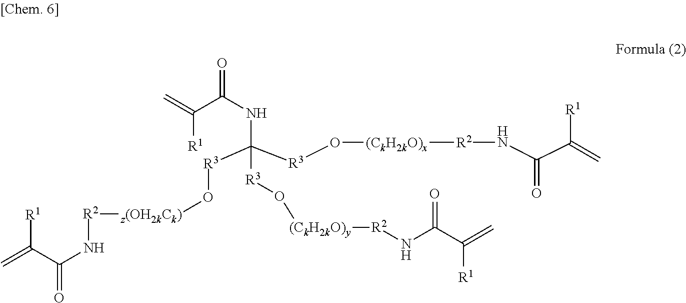
In the formula (2), R¹ represents a hydrogen atom or a methyl group; R² represents a linear or branched alkylene group having 2 to 4 carbon atoms in which an oxygen atom and a nitrogen atom, bonded to both terminals of R², are not bonded to the same carbon atom of R²; R³ represents a divalent linking group; k represents 2 or 3; and x, y, and z each independently represent an integer of 0 to 6 in which a value of x+y+z satisfies an integer of 0 to 18.
